(19) United States
(12) Patent Application Publication
(10) Pub. No.: US 2020/0005656 A1
(43) Pub. Date: Jan. 2, 2020

(54) DIRECTION FINDING IN AUTONOMOUS VEHICLE SYSTEMS

(71) Applicant: Intel Corporation, Santa Clara, CA (US)

(72) Inventor: Esa SAUNAMAEKI, Virrat (FI)

(21) Appl. No.: 16/569,675

(22) Filed: Sep. 13, 2019

(51) Int. Cl. G08G 5/00; B64D 47/02; G05D 1/10; G05D 1/00; B64C 39/02; G05D 1/06

(52) U.S. Cl. CPC G08G 5/0069; B64D 47/02; G08G 5/0043; G05D 1/104; B64C 2201/12; B64C 39/024; G05D 1/0676; B64C 2201/146; G05D 1/0027

(57) ABSTRACT

Devices and methods are provided for determining a location independent of a global navigation satellite system (GNSS) signal in autonomous vehicles, especially in unmanned aerial vehicles (UAVs). An exemplary device includes one or more receivers or sensors configured to receive first information, wherein the one or more receivers or sensors is configured to obtain at least a subset of the first information from an external source, wherein at least a first of the one of the one or more receivers or sensors includes a transceiver configured to communicate with other UAVs in a first subset of UAVs. The exemplary device also includes one or more processors configured to share the first information with at least a one other UAV in the first subset, receive second information from the other UAV, and determine a path to the first location based on at least the second information.

### TECHNICAL FIELD

Exemplary implementations described herein generally relate to positioning in autonomous vehicle systems.

### BACKGROUND

In most cases, autonomous vehicles largely, or even entirely, depend on positioning signals such as global navigation satellite system (GNSS), e.g. Global Positioning System (GPS), signals or ultra-wideband (UWB) signals to coordinate vehicle movements and/or configurations. For example, outdoor drone-based light shows may heavily rely on GNSS signals to coordinate precise drone movement, or, in the case of indoor shows, may rely on UWB positioning techniques. In some cases, there may be reduced central positioning signal reception (e.g. due to GPS/RF jammers, environmental conditions, country/state specific regulations, high interference scenarios, intentional interference by a third-party, etc.), which may severely impact the performance of the autonomous vehicle system operation.

In drones, for example, it is important that the GNSS or UWB frequency is as clear as possible from other noise and/or interference. Otherwise, flying the drones and ensuring safe landing may be challenging or impossible. In outdoor navigation cases, for example, drones may be largely dependent on GNSS signals for position control. In indoor navigation cases, the system may be based on an UWB anchor network and if there are noise and/or disturbances on the UWB frequencies, the scenario is similar to losing a GNSS signal. Current methods for responding to the loss of GNSS or UWB signals include emergency landing in motors off mode or smooth landing with motors on, but these solutions may be problematic in cases where a specific landing zone may be desired, for example, to avoid landing in the audience or in an area which would damage the drone or render it irretrievable (e.g., in a body of water). Furthermore, such options may not account for collision avoidance between the drones.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows an unmanned aerial vehicle (UAV) according to some aspects.

FIG. 2 shows a general direction finding system according to some aspects.

FIG. 3 shows a second general direction finding system according to some aspects.

FIG. 4 shows a third general direction finding system according to some aspects.

FIG. 5 shows different beacon sources according to some aspects.

FIG. 6 shows components of the different beacon sources according to some aspects.

FIG. 7 shows direction finding systems with landing zones according to some aspects.

FIG. 8 shows a drone side perspective of a direction finding system according to some aspects.

FIG. 9 shows a direction finding system with guiding lights according to some aspects.

FIG. 10 shows another perspective of a direction finding system with guiding lights according to some aspects.

FIG. 11 shows a direction finding system with guiding lights and camera modules according to some aspects.

FIG. 12 shows another perspective of a direction finding system with guiding lights and camera modules according to some aspects.

FIG. 13A-13E show exemplary flight control options in a direction finding system according to some aspects.

FIG. 14A-14B show exemplary camera placement options according to some aspects.

FIG. 15 shows a camera module according to some aspects.

FIG. 16 shows message sequence charts (MSCs) for communication between UAVs according to some aspects.

FIG. 17 shows a flowchart describing a direction finding method according to some aspects.

FIG. 18 shows a flowchart describing a second direction finding method according to some aspects.

FIG. 19 shows a direction finding system showing radiation patterns according to some aspects.

FIG. 20 shows a drone with an exemplary radiation pattern of a direction finding antenna according to some aspects.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration.” Any aspect of the disclosure described herein as “exemplary” is not necessarily to be construed as preferred or advantageous over other aspects of the disclosure.

Throughout the drawings, it should be noted that like reference numbers are used to depict the same or similar elements, features, and structures.

The terms “at least one” and “one or more” may be understood to include a numerical quantity greater than or equal to one (e.g., one, two, three, four, [. . . ], etc.). The term “a plurality” may be understood to include a numerical quantity greater than or equal to two (e.g., two, three, four, five, [. . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like.

The term “map” used with regard to a two- or three-dimensional map may include any suitable way of describing positions of objects in the two- or three-dimensional space.

According to various aspects, a voxel map may be used to describe objects in the three dimensional space based on voxels associated with objects. To prevent collision based on a voxel map, ray-tracing, ray-casting, rasterization, etc., may be applied to the voxel data.

Any vector and/or matrix notation utilized herein is exemplary in nature and is employed solely for purposes of explanation. Accordingly, aspects of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the aspects described herein may utilize include, but are not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication arrangement/Extended Total Access Communication arrangement (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.12ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication arrangements such as Intelligent-Transport-Systems, and other existing, developing, or future radio communication technologies. As used herein, a first radio communication technology may be different from a second radio communication technology if the first and second radio communication technologies are based on different communication standards.

Aspects described herein may use such radio communication technologies according to various spectrum management schemes, including, but not limited to, dedicated licensed spectrum, unlicensed spectrum, (licensed) shared spectrum (such as LSA, “Licensed Shared Access,” in 2.3-2.4 GHz, 3.4-3.6 GHz, 3.6-3.8 GHz and further frequencies and SAS, “Spectrum Access System,” in 3.55-3.7 GHz and further frequencies), and may be use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, aspects described herein can also employ radio communication technologies on a secondary basis on bands such as the TV White Space bands (typically below 790 MHz) where in particular the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, aspects described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. Aspects described herein can also use radio communication technologies with different Single Carrier or OFDM flavors (CP-OFDM, SC-FDMA, SC-OFDM, filter bank-based multicarrier (FBMC), OFDMA, etc.) and in particular 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

In accordance with some aspects, the positioning signals described herein may refer to GNSS signals or UWB signals and be used interchangeably. It is appreciated that the several Figures and/or Examples may describe methods and/or devices which are configured to provide positioning techniques upon the loss of a GNSS signal, but it is appreciated that similar methods and/or devices may be configured to provide the same positioning techniques upon the loss of a UWB signal and vice versa. For example, methods and/or devices described herein may be configured to function using GNSS signals in outdoor scenarios and using UWB signals in indoor scenarios.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions. The term “calculate” encompass both ‘direct’ calculations via a mathematical expression/formula/relationship and ‘indirect’ calculations via lookup or hash tables and other array indexing or searching operations.

The term “software” refers to any type of executable instruction, including firmware.

The word “compass” may refer to any device that is capable of directionally detecting and/or measuring a magnetic field. The compass may specifically refer to a magnetometer, which may measure the strength and direction of one or more magnetic fields. The measurements of the compass may be made according to any, or any combination, of the three physical axes (x-axis, y-axis, and/or z-axis). The compass measurements may include a combination of the earth's magnetic field and any local magnetic field or fields. The word compass may specifically refer to a compass on a printed circuit boards (“PCBs”). Such a Compass PCB may be referred to alone, or as part of a compass system for an unmanned aerial vehicle (UAV).

The word Inertial Measurement Unit (“IMU”) may refer to any device or devices that measure a body's specific force, angular rate, and/or magnetic field. The IMU may include any of one or more accelerometers, one or more gyroscopes, one or more magnetometers, one or more compasses, or any combination thereof.

Autonomous vehicles, such as UAVs (i.e., drones), heavily rely on GNSS signals for configuration control. This may include, but is not limited to, controlling the movement, speed, relative velocity, location, altitude, spacing, rotation, etc. of one or more UAVs in a cluster of UAVs. Upon loss of the GNSS signal (e.g., GPS), these autonomous vehicles, especially aerial vehicles, must have a safe and reliable way to arrive at a predetermined location (in the broadest sense, this may include simply arriving at a ground location for UAVs) so as to minimize damage to the vehicles and/or their surroundings. While current solutions such as motors off mode landing or smoothing landing with motors on mode exist, these solutions provide very limited options for landing with little to no control.

In some aspects of this disclosure, devices and methods are provided to allow for autonomous vehicles, e.g., UAVs, to determine a location and arrive at the location safely even in the case of loss of a GNSS signal. Accordingly, in some aspects, the procedures described herein may be triggered when a device or a control unit determines that there is poor reception of a GNSS signal, e.g., by determining that the GNSS signal falls below a certain threshold. This threshold may be a predetermined value which signifies that safe and/or accurate communications in the drone system may no longer be achieved.

In one aspect, for example, a cluster of drones (i.e., a subset of drones) in a large drone fleet (i.e., a plurality of drones which is at least the size of the subset, but in many cases, may be much larger so that the fleet includes multiple distinct subsets of drones) may be grouped together and be configured to communicate with one another upon loss of a GNSS signal in order to determine a location and be able to chart paths to arrive safely at the location without GNSS assistance. Each of the drones in the cluster has a receiver and a directional antenna with one or more processors configured to run mathematical calculations. The drone system may include one or more radio frequency (RF) sources, e.g. RF beacons, configured to transmit signals in frequencies distinct from those used in GNSS. Based on readings and/or information taken and/or received at one or more of the drones in the cluster, for example, magnetometer readings, barometer readings, RF signal reception, altitude measurement, etc., one or more of the drones in the cluster may calculate the direction of the RF sources. Based on the data from each of the drones in the cluster, a “master” drone in the cluster (or alternatively, the drones in the cluster in the collective) may determine the location of the RF source and share the information with the other drones in the cluster so that each of the drones may determine a path home relative to the RF source. In the case of an emergency, e.g. GNSS signal lost, the drones may use this system to find a safe path to home, i.e. a predetermined safe landing zone.

In another aspect, the drones may be clustered like described above, but instead of using one or more RF signal sources to determine a location to land, the drones may use other sources such as lights, infrared, thermal sources, and other types of such sources detectable by the drones to transmit the location of the landing zones. For example, in the instance of using lights, the drones can detect the lights with their cameras (or other optical sensors) and determine the distance and direction of the light source(s) and based on the data obtained at each drones in a cluster, determine the location of the light source(s) and a landing zone relative to the light source(s).

In another aspect, a system may be implemented to use a series of cameras and guiding lights to communicate a safe path to a landing zone to drones in the event that the GNSS signal reception falls below a signal quality threshold. This threshold may be a predetermined value which signifies that reliable and/or accurate communications in the drone system may no longer be attainable. The system may user light source(s) such as visible or infrared (IR) lights which are placed at a level below the drones so as to guide the drones safely to the landing zone(s).

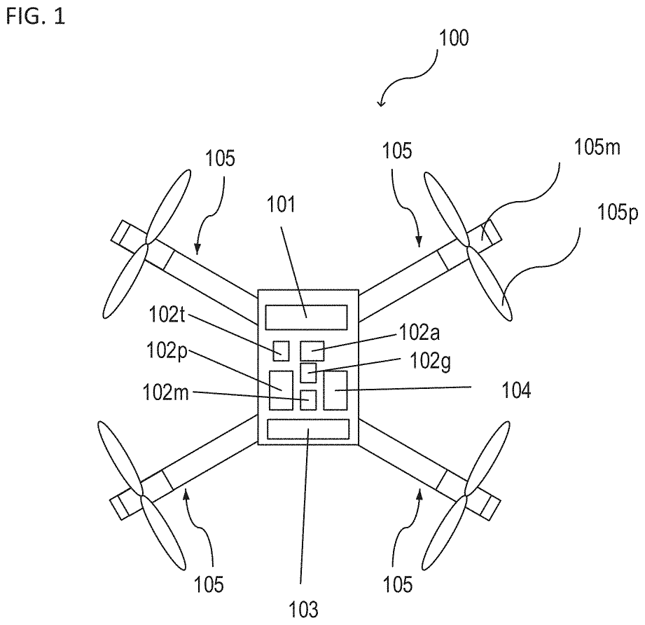

FIG. 1 illustrates an unmanned aerial vehicle 100 in a schematic view, according to various aspects. The unmanned aerial vehicle 100 may include a plurality of (e.g., three or more than three, e.g., four, six, eight, etc.) vehicle drive arrangements 105. Each of the vehicle drive arrangements 105 may include at least one drive motor 105m and at least one propeller 105p coupled to the at least one drive motor 105m. According to various aspects, the one or more drive motors 105m of the unmanned aerial vehicle 100 may be electric drive motors. Therefore, each of the vehicle drive arrangements 105 may be also referred to as electric drive or electric vehicle drive arrangement.

Further, the unmanned aerial vehicle 100 may include one or more processors 102p configured to control flight or any other operation of the unmanned aerial vehicle 100. The one or more processors 102p may be part of a flight controller or may implement a flight controller. The one or more processors 102p may be configured, for example, to provide a flight path based at least on a current position of the unmanned aerial vehicle 100 and a target positon for the unmanned aerial vehicle 100. In some aspects, the one or more processors 102p may control the unmanned aerial vehicle 100 based on a map. In some aspects, the one or more processors 102p may control the unmanned aerial vehicle 100 based on received control signals. As an example, a flight control system may transmit control signals to the unmanned aerial vehicle 100 to cause a movement of the unmanned aerial vehicle 100 along a predefined flight path. In some aspects, the one or more processors 102p may directly control the drive motors 105m of the unmanned aerial vehicle 100, so that in this case no additional motor controller may be used. Alternatively, the one or more processors 102p may control the drive motors 105m of the unmanned aerial vehicle 100 via one or more additional motor controllers. The motor controllers may control a drive power that may be supplied to the respective motor. The one or more processors 102p may include or may implement any type of controller suitable for controlling the desired functions of the unmanned aerial vehicle 100. The one or more processors 102p may be implemented by any kind of one or more logic circuits.

According to various aspects, the unmanned aerial vehicle 100 may include one or more memories 102m. The one or more memories 102m may be implemented by any kind of one or more electronic storing entities, e.g. one or more volatile memories and/or one or more non-volatile memories. The one or more memories 102m may be used, e.g., in interaction with the one or more processors 102p, to implement various desired functions, according to various aspects.

Further, the unmanned aerial vehicle 100 may include one or more power supplies 104. The one or more power supplies 104 may include any suitable type of power supply, e.g., a directed current (DC) power supply. A DC power supply may include one or more batteries (e.g., one or more rechargeable batteries), etc.

According to various aspects, the unmanned aerial vehicle 100 may include a localization device 101. The localization device 101 may be configured to provide (e.g. receive, send, generate, as examples) position information representing a positional relationship of the localization device 101 relative to one or more other localization devices in a vicinity of the unmanned aerial vehicle 100. In some aspects, the localization device 101 may include one or more wireless access points configured to determine a direction and/or distance to one or more other localization devices in a vicinity of the unmanned aerial vehicle 100. In some aspects, the localization device 101 may include a wireless tracker configured to allow a determination of a positional information (e.g. a direction, an absolute distance, a relative distance, etc.) of the localization device 101 relative to one or more other localization devices in a vicinity of the unmanned aerial vehicle 100. The localization device 101 may include, for example, any suitable transmitter, receiver, transceiver, etc., that allows for a detection of an object and information representing the position of the object. The transmitter, receiver, transceiver, etc. may operate based on wireless signal transmission, e.g. based in ultra-wideband transmission.

In some aspects, the unmanned aerial vehicle 100 may further include a position detection device 102g. The position detection device 102g may be based, for example, on global positioning system (GPS) or any other available positioning system. The position detection device 102g may be used, for example, to provide position and/or movement data of the unmanned aerial vehicle 100 itself (including a position in GPS coordinates, e.g., a flight direction, a velocity, an acceleration, etc.). However, other sensors (e.g., image sensors, a magnetic senor, etc.) may be used to provide position and/or movement data of the unmanned aerial vehicle 100. In some aspects, the position detection device 102g may be a GPS tracker.

According to various aspects, unmanned aerial vehicle may include at least one transceiver 102t configured to provide an uplink transmission and/or downlink reception of radio signals including data, e.g. video or image data and/or commands. The at least one transceiver 102t may include a radio frequency (RF) transmitter and/or a radio frequency (RF) receiver. The RF transmitter and/or receiver may be configured to communicate according to any of the wireless communications technologies mentioned herein. The at least one transceiver may be coupled to one or more antennas 102a.

The at least one transceiver 102t and the one or more antennas 102a may transmit and receive radio signals on one or more radio access networks. One or more of the processors 102p may direct such communication functionality according to the communication protocols associated with each radio access network, and may execute control over one or more antennas 102a and transceiver 102t in order to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of unmanned aerial vehicle 100 shown in FIG. 1 depicts only a single instance of such components.

The unmanned aerial vehicle 100 may transmit and receive wireless signals with one or more antennas 102a, which may be a single antenna or an antenna array that includes multiple antennas. In some aspects, one or more antennas 102a may additionally include analog antenna combination and/or beamforming circuitry. In the receive (RX) path, the at least one transceiver 102t may receive analog radio frequency signals from one or more antennas 102a and perform analog and digital RF front-end processing on the analog radio frequency signals to produce digital baseband samples (e.g., In-Phase/Quadrature (IQ) samples) to provide to one or more processors 102p, which may include a baseband modem. The at least one transceiver 102t may include analog and digital reception components including amplifiers (e.g., Low Noise Amplifiers (LNAs)), filters, RF demodulators (e.g., RF IQ demodulators)), and analog-to-digital converters (ADCs), which the at least one transceiver 102t may utilize to convert the received radio frequency signals to digital baseband samples. In the transmit (TX) path, the at least one transceiver 102t may receive digital baseband samples from baseband modem of one or more processors 102p and perform analog and digital RF front-end processing on the digital baseband samples to produce analog radio frequency signals to provide to one or more antennas 102a for wireless transmission. The at least one transceiver 102t may thus include analog and digital transmission components including amplifiers (e.g., Power Amplifiers (PAs), filters, RF modulators (e.g., RF IQ modulators), and digital-to-analog converters (DACs), which the at least one transceiver 102t may utilize to mix the digital baseband samples received from baseband modem of one or more processors 102p and produce the analog radio frequency signals for wireless transmission by one or more antennas 102a. In some aspects, a baseband modem of included in the one or more processors 102p may control the RF transmission and reception of the at least one transceiver 102t, including specifying the transmit and receive radio frequencies for operation of the at least one transceiver 102t.

The unmanned aerial vehicle 100 may further include (or may be communicatively coupled with) an inertial measurement unit (IMU) and/or a compass unit, i.e. a magnetometer, or other measurement modules/sensors, i.e. gyroscope, barometer, accelerometer, etc. The inertial measurement unit may allow, for example, a calibration of the unmanned aerial vehicle 100 regarding a predefined plane in a coordinate system, e.g., to determine the roll and pitch angle of the unmanned aerial vehicle 100 with respect to the gravity vector (e.g. from planet earth). Thus, an orientation of the unmanned aerial vehicle 100 in a coordinate system may be determined. The orientation of the unmanned aerial vehicle 100 may be calibrated using the inertial measurement unit before the unmanned aerial vehicle 100 is operated in flight modus. However, any other suitable function for navigation of the unmanned aerial vehicle 100, e.g., for determining a position, a velocity (also referred to as flight velocity), a direction (also referred to as flight direction), etc., may be implemented in the one or more processors 102p and/or in additional components coupled to the one or more processors 102p. To receive, for example, position information and/or movement data about one or more objects in a vicinity of the unmanned aerial vehicle 100, information of a depth imaging system and image processing may be used. Further, to store the respective information in the (e.g., internal) map of the unmanned aerial vehicle 100, as described herein, at least one computing resource may be used.

The unmanned aerial vehicle 100 may be referred to herein as drone. However, a drone may include other unmanned vehicles, e.g. unmanned ground vehicles, water vehicles, etc. In a similar way, any vehicle having one or more autonomous functions based on position information of the vehicle (e.g. one or more autonomous functions associated with a control of a movement of the vehicle) may include the functionalities described herein.

Various aspects are related to a localization system that is configured to allow a high precision localization of comparatively small objects. Such a small object may include a vehicle having a small form factor. The vehicle may be a drone or any other vehicle having one or more autonomous functions to control movement of the vehicle based on a localization thereof. As an example, a drone may include frame and/or a body surrounding one or more electronic components (e.g. one or more processors, one or more sensors, one or more electric drive components, one or more power supply components, as examples).

Further, various aspects are related to a vehicle control system that may be used to control movement of a plurality of vehicles (e.g. of more than 20, more than 50, or more than 100 vehicles). The plurality of vehicles may be controlled in accordance with a predefined movement plan, wherein a precise localization of the vehicles may be beneficial so that the actual movement path of the vehicle deviates as less as possible from the predefined movement path. A precise localization of a plurality of small drones may be beneficial to control a movement of the plurality of drones simultaneously (illustratively as a swarm) and to perform a predefined choreography as precise as possible, e.g. to perform a light show or to display a predefined image, as examples.

In general, various autonomous operation modes of a drone may require a knowledge of the position of the drone. A position of a drone may be determined based on GPS (Global Positioning System) information, e.g. RTK (Real Time Kinematic) GPS information. However, for some reasons, a drone may not be capable of carrying electronic components that allows for a precise localization of the drone based on GPS (e.g. RTK-GPS) or, if it does, the drone may not be capable of utilizing localization services based on GPS or other GNSS signals at any given moment. As an example, the drone may be too small and/or too light to carry a precise GNSS localization device, or there may be significant interference and/or noise in the GNSS frequency thereby rendering GNSS services unusable. For example, a precise localization may be a challenging aspect for operating drones, e.g. unmanned aerial vehicles, especially if a GNSS signal, e.g. GPS, is lost. In another aspect, the positioning system of the drone may include or be based on an UWB radio system, e.g. for use in indoor cases. If there is noise in the UWB radio system, the drones may rely on the methods and/or devices provided herein in order to find a direction to a safe landing zone. The system may, for example, rely on a light based guidance system which employs infrared lighting since the audience may be closer to the flight area.

As an example, in the case that drones are operated in a swarm, e.g. with an increasing number of drones per volume (e.g. with more than one drone per cubic meter, e.g. more than five drones per cubic meter, or more than ten drones per cubic meter, as examples) a more precise localization may be required compared to an operation of, for example, a single drone, e.g. a drone for delivering goods and the like. A GPS localization with a precision of about ±1 m may be acceptable for flying a drone in 100 m altitude, but this precision may be in some cases unacceptable, e.g. for an unmanned aerial vehicle doing an indoor light show. However, a precision tracking/localization of an unmanned aerial vehicle or any other drone may not be limited to an indoor usage during a light show. A general problem may be a high precision tracking/localization for a small sized unmanned aerial vehicle in an outdoor area.

In some aspects, UAV 100 may further include one or more camera modules 103, which may each include a camera sensor and a camera. Camera modules 103 may be configured to obtain information from the UAV's 100 surrounding. For example, multiple camera modules 103 may be placed in different places on UAV 100 so as to maximize the UAV's field of vision. In some aspects, camera module 103 may be configured to rotate and focus on different areas with respect to UAV 100 in order to increase its field of vision. Camera module 103 may be configured to observe images in one or more of the visible light spectrum, in the infrared spectrum, ultraviolet spectrum, etc.

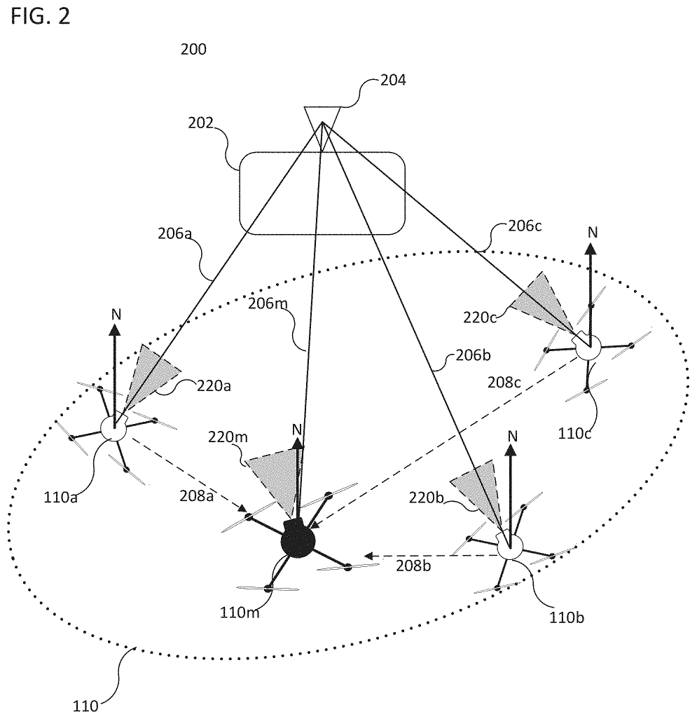

FIG. 2 shows a direction finding system 200 according to some aspects. It is appreciated that system 200 is exemplary in nature and may therefore be simplified for purposes of this explanation.

In some aspects, beacon 202 may be a radio frequency beacon configured with equipment, e.g. an RF control circuit and an RF antenna 204, to transmit RF signals. In some aspects, the RF control circuit may further be configured to receive RF signals from other devices, e.g. other RF beacons or UAVs. The RF antenna 204 may, for example, be an antenna array with multiple antenna elements to enable the beacon to transmit signals employing beamforming methods.

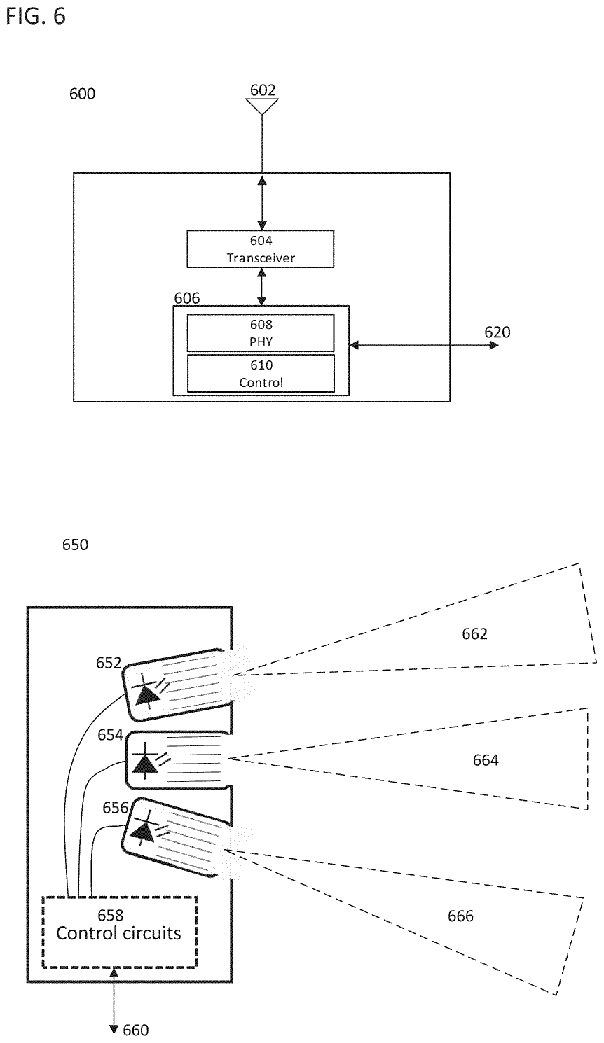

In other aspects, beacon 202 may be a light beacon configured with a one or more lighting elements (e.g. light emitting diodes (LED)s, light bulbs, laser, etc.) 204 configured to emit light. The lighting elements 204 may include structures to emit light via light beams and manipulate the light beams in one or more specific directions (e.g. as shown in 650 FIG. 6). In some aspects, the light pattern(s) may also be projected on any suitable surface which the drones may then observe and determine their flight control patterns accordingly. The projected lights may be based on laser beams or a liquid crystal display (LCD) projector or the like.

A group 110 of four drones, 110a, 110b, 100c, and 110m, are located within range of receiving signals from beacon 202. While only four drones are shown in FIG. 2, it is appreciated that any number of drones may be within range of beacon 202. For example, in light shows, there may be hundreds of drones. In some aspects, the drones may be divided into their respective subsets before an event, e.g. light show, so that during the flight the distance between the drones can be maintained in a manner which achieves the best possible location determination accuracy.

In some aspects, the drones in the entire drone swarm (i.e. overall drone group) may be divided into subsets. For example, each subset may include 2-20 drones, or 2-10 drones, or 2-5 drones. For illustrative purposes, the subset of drones 110 in FIG. 2, which may belong to an overall drone swarm of more drones, includes four drones: 110a, 110b, 100c, and 110m.

In the case the beacon 202 is an RF beacon, it may be equipped to broadcast an RF signal in a single frequency or over multiple frequencies. If broadcasting over a single frequency, this may include the frequency being a pre-determined frequency known to the drones so that when the GNSS signal is lost, the drones may be configured to automatically tune to the pre-determined frequency. In other instances, the drones may be configured to periodically monitor the pre-determined frequency even in the case the GNSS signal is adequate for localization services. In the case that the RF signal is broadcast over multiple frequencies, several schemes may be employed. For example, the beacon may be configured to transmit over a respective frequency to one or more subsets of drones, and use another frequency to communicate with another subset of drones. Additionally, the frequencies may be allotted so that one frequency is assigned to the RF beacon broadcast signal, and another one or more frequencies are assigned for inter-drone communication, i.e. within drones of each subset, and, in other aspects, between master drones of each subset. In another example, frequency hopping schemes may be employed. The frequency hopping pattern may be a predetermined pattern known to all devices in system 200, of the frequency pattern may be communicated to the drones, e.g. during the drones' periodic monitoring of the predetermined frequency whilst the GNSS is being used for direction finding.

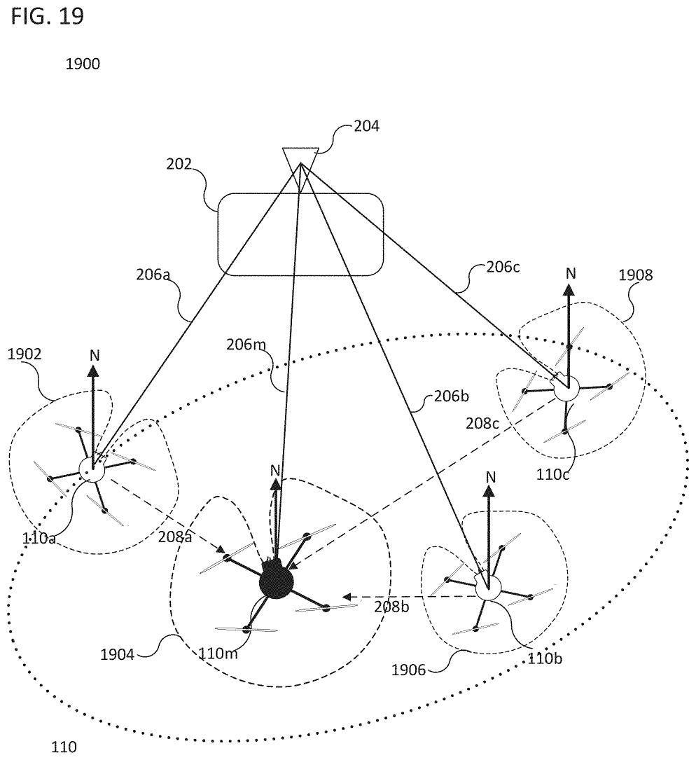

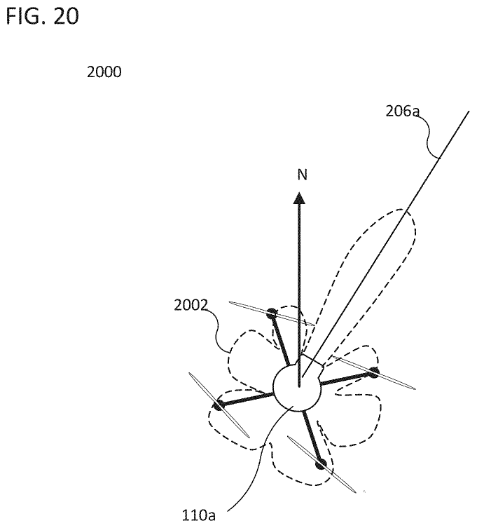

In any case, once the GNSS signal or UWB signal is lost or falls below a threshold (where the threshold is provided so that falling below the threshold is indicative that the GNSS or UWB signal can no longer be relied upon to provide accurate location information), the group of drones 110 may be configured to use the RF signals received from the beacon 202 and run calculations based on the direction and/or strength of the received RF signals in combination with information from their directional antenna (e.g. internal compass or magnetometer or the like). Several illustrations according to some aspects are shown in greater detail in FIGS. 19 and 20. In FIG. 2, the directional antenna's influence on said calculations is illustrated by the bold arrows with an N pointing up from each of the drones. Therefore, each of the drones in 110 may be able to determine the direction of the received RF signal from beacon 202 based on the angle at which the RF signal arrives with respect to a bearing, in this case North (N), of the directional antenna. For example, drone 110a may receive RF signal 206a from the beacon 202, and use the relative angle of the received signal with respect to its directional antenna reading (N) to use in the calculation of the direction of the beacon 202. Furthermore, the strength of the signal may also be determined so that when combined with the other directional reading of the other drones in group 100, the readings with a higher signal strength may be given more weight in the calculations.

Once each of the drones in the group 100 receives the RF signal from beacon 202, they may be configured to share the information with other drones in the group 100 so that they may determine the location of the beacon 202. After the location of the beacon is determined, the drones in group 100 may use this information to determine a safe path home. This may include a safe landing zone near beacon 202 or at a pre-determined location relative to beacon 202.

In some aspects, each of the drones in group 100 may be configured to share information of the received RF signal from beacon 202 and its own internal directional information (e.g. internal compass reading) with the other drones in the group so that each of the drones may independently perform a calculation of the position of the RF beacon 202.

In some aspects, and as illustrated in FIG. 2, the group of drones 100 may include a master drone 110m. This master drone may be configured to receive each of the other drones' (1101-110c) data, shown by arrows 208a-208c, regarding each respective received RF signal and internal directional information to perform the RF beacon location calculation and share this calculation with the rest of the group 110. In this manner, the RF beacon 202 location determination is centralized at and managed by master drone 110m, which may then provide coordination of the flight patterns of each drone in group 110 to safely fly home, i.e. to a landing zone, upon loss of GNSS signal and/or services. In this respect, the master drone 110m may be equipped with improved calculation performance features. In some aspects, the role of the master drone 110m may be shared between multiple drones of group 110 or may even be alternated between all the drones in the group.

In some aspects, ground units (not pictured) may be deployed to provide assistance in the direction calculations. For example, the master drone 110m may gather all the raw data for a group 100, and transmit it to a ground unit specifically configured to perform the calculations accurately and quickly, which then replies to the master drone 110m with the precise location of the RF beacon 202. In some aspects, the master drone 110m may be a drone which follows and monitors the group of drones 110 and does not actively participate in the group of drone's activities, e.g. in a drone light show. In this sense, the master drone 110m oversees the other drones in the group 110 and plays an active role in the case that the GNSS or UWB signal is lost since more power may be necessary to determine and control the safe paths for each of the drones in the group 110 to arrive at a safe location.

In the case the beacon 202 is a light beacon, it may be equipped to transmit light via lighting elements 204 in one or more ways. For example, lighting elements 204 may include a series of LEDs or other light sources (e.g. infrared (IR) lights) to emit one or more lighting patterns. Also, the lighting elements 204 may be equipped with mechanical and/or optical structures to guide the light in a specific manner, i.e. direct light beams in a specific direction, e.g. towards one or more selected subsets of drones of the drone swarm. An example of this is shown in FIG. 6.

Each of the drones in group 110 may be equipped with camera or other light sensors (e.g. IR sensors) as well as one or more directional antennas/sensors (e.g. magnetometer, barometer, etc.). For example, each of the drones may have a camera with a viewing range, e.g. for drone 110a, the viewing range is illustrated by area 220a. In some aspects, the drones may be equipped with multiple cameras so that each of the drones may have multiple viewing ranges, or may be equipped with one or more cameras modules which rotate relative to its body and thus may have a higher viewing range than a fixed, non-movable camera module.

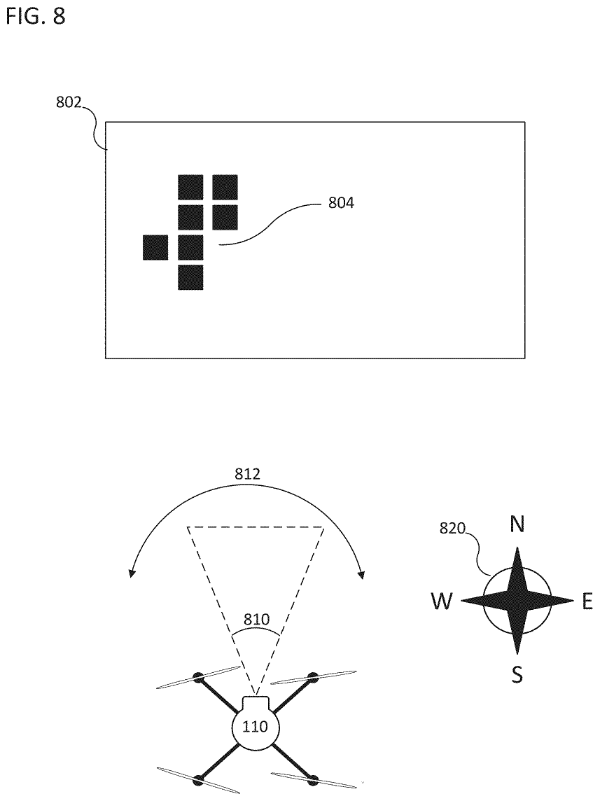

Similar to the case where the beacon is an RF beacon (explained above), if the beacon 202 is a light beacon, each of the drones may be configured to perform calculations based on the direction and/or intensity of the light emitted from beacon 202 and also its own internal directional data (e.g. compass, magnetometer, barometers, etc.) to estimate the location of the light source (i.e. beacon) and calculate a safe path home, e.g. a pre-determined landing zone. FIG. 8 provides further details with respect to the observed light patterns and directional observation aspects of each of the drones.

Once the GNSS signal is lost or falls below a threshold, where the threshold is provided so that falling below the threshold is indicative that the GNSS signal can no longer be relied upon to provide accurate location information, the group of drones 110 may be configured to use the observed light patterns from beacon 202 and run calculations based on the direction and/or intensity of the observed light patterns in combination with their directional antenna, internal compass, and/or magnetometer, etc. As previously explained, in FIG. 2, the directional antenna's influence on said calculations is illustrated by the bold arrows with an N pointing up from each of the drones. Therefore, each of the drones in 110 may be able to determine the direction of the observed light signal from beacon 202 based on the angle at which the light is observed with respect to a bearing, in this case North (N), of the directional antenna. For example, drone 110a may observe a light (in this case, illustrated by 206a) from the beacon 202, and use the relative angle of the observed light signal with respect to its directional antenna reading (N) to use in the calculation of the direction of the beacon 202. Furthermore, the intensity of the observed light may also be determined so that when combined with the other directional reading of the other drones in group 100, the readings with a higher light intensity may be given more weight in the calculations.

Once each of the drones in the group 100 observes the light (i.e. receives a light signal) from beacon 202, they may be configured to share the information with other drones in the group 100 so that they may determine the location of the beacon 202. After the location of the beacon is determined, the drones in group 100 may use this information to determine a safe path home. This may include a safe landing zone near beacon 202 or at a pre-determined location relative to beacon 202.

In some aspects, each of the drones in group 100 may be configured to share information of the received light signal from beacon 202 and its own internal directional information (e.g. internal compass reading) with the other drones in the group so that each of the drones may independently perform a calculation of the position of the light beacon 202.

In some aspects, and as illustrated in FIG. 2, the group of drones 100 may include a master drone 110m. This master drone may be configured to receive each of the other drones' (1101-110c) data, shown by arrows 208a-208c, regarding each respective received light signal and internal directional information to perform the light beacon location calculation and share this calculation with the rest of the group 110. In this manner, the light beacon 202 location determination is centralized at and managed by master drone 110m, which may then provide coordination of the flight patterns of each drone in group 110 to safely fly home, i.e. to a landing zone, upon loss of GNSS signal and/or services. In this respect, the master drone 110m may be equipped with improved calculation performance features. In some aspects, the role of the master drone 110m may be shared between multiple drones of group 110 or may even be alternated between all the drones in the group.

In some aspects, ground units (not pictured) may be deployed to provide assistance in the direction calculations. For example, the master drone 110m may gather all the raw data for a group 100, and transmit it to a ground unit specifically configured to perform the calculations accurately and quickly, which then replies to the master drone 110m with the precise location of the light beacon 202.

In some aspects, the system 200 may be deployed with multiple beacons, e.g. all RF beacons, all light beacons, beacons equipped with RF and light transmission capabilities, or any combination thereof. If equipped with multiple beacons, each of the RF beacons may, for example, have its own transmission frequency or frequency hopping pattern and be modulated, pulsed, shaped, encoded, and/or synchronized to improve location and accuracy and detection of the different RF sources. Similarly, each of the light beacons may be equipped so that its light emission is modulated, pulsed, shaped, encoded, and/or synchronized to improve location and accuracy and detection of the different light sources.

In some aspects, the drones in group 110 of system 200 may employ their own RF-based communication system (i.e. baseband processing circuitry, digital signal processors, RF transceivers, antennas, etc.) to communicate with one another. However, the drones in group 100 may also use other methods to communicate with one another, such as IR, visible light signals, acoustic signals, ultrasonic signals, etc. for communication.

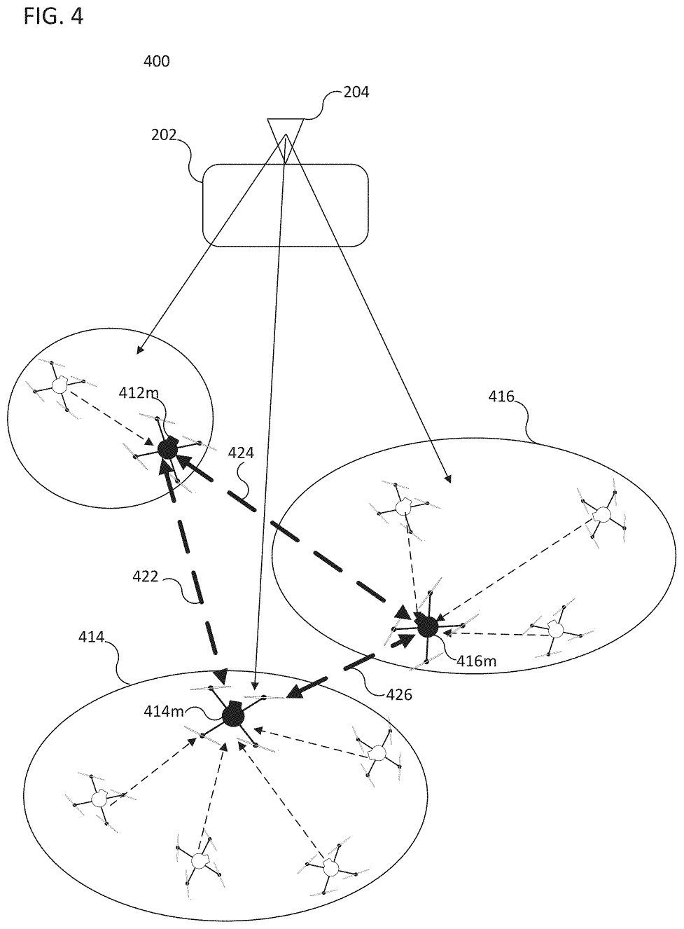

In some aspects, in the case where there is RF jamming or other local RF interferences at the beacon side in system 200, the system may use the transmission of light signals from beacon 202 (potentially, along with guiding lights as explained later on in this disclosure) to arrive at the landing zone, but the drones within group 110 (and also inter-group communication of master drones, for example, as shown in FIG. 4) may use RF communication to transfer and communicate with one another.

In an exemplary case for a drone-run programmed light show, each of the drones are programmed to run their own specific flight pattern. In this case, if RF noise starts to disturb the GNSS signal and the GNSS signal is lost, each drone may have a pre-defined process to determine a flight path and fly safely to the landing zone. Each drone may use a light signal, an RF signal, or combination of the two received from a beacon and/or guiding lights to find a landing zone. Since the location of each drone is approximately known when the light show stops due to the interferences (e.g. RF jamming), the drones can be programmed so that those drones, which are closest to the landing zone are the first that start to fly to landing zone. During the light show, the system may also change the master drone inside the group to ensure that the master drone always has the best visibility to the beacon or guiding lights. The group can use, for example, barometer data to determine and select the best possible master. In the RF communication case between drones, each group may use its own RF channel or shared channel with another group(s), when master drones communicate with each other to define an own time slot for each group.

In some aspects, for the RF based direction finding scheme, the drones may run the direction finding process from time to time and also when the GPS signal is available. In this manner, the drones can utilize the direction finding system to compare the calculated data to the GPS data and use self-learning algorithms to improve accuracy in the case when the GPS signal is lost. The direction finding system may use multiple beacons, which are synchronized with each another. The direction finding system may also use high performance clock references (e.g., providing accurate times), and the system may run distance calculations based on timing of the RF signals. The RF beacon system may use low frequency (for example 6.78 MHz, 13.56 Mhz or 27.12 MHz ISM bands) or any higher ISM or any other frequencies which are allocated for this purpose. In the RF based direction finding case, the system may use any type of antenna, which provides a suitable radiation pattern for purposes of this disclosure, e.g. a loop or phased antenna group. The RF based direction finding system of this disclosure may also be used in self-driving robot systems at the ground level (or in aquatic environments) since the system may improve location accuracy when the GPS signal is too weak because of local interferences, trees, or buildings.

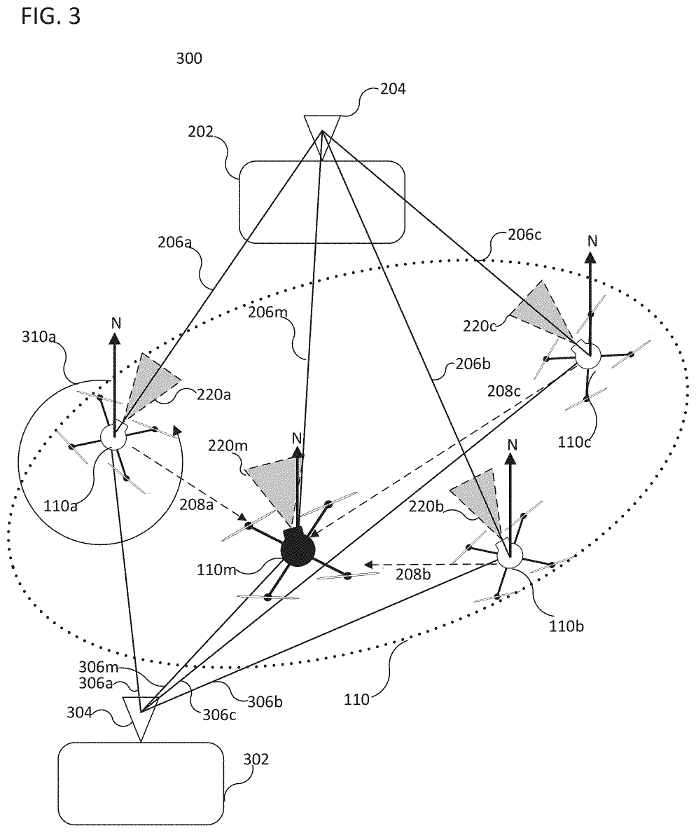

FIG. 3 shows a system 300 similar to that shown in FIG. 2 with the addition that multiple beacons are employed to improve the direction finding techniques according to some aspects. It is appreciated that system 300 is exemplary in nature and may thus be simplified for purpose of this explanation. In addition to all the details described with respect to system 200 above, the system may employ one or more additional beacons to improve the accuracy of the location/direction finding schemes of the system. In system 300, an additional beacon 302 is shown, but it is appreciated that multiple other beacons may be employed in order to increase the accuracy and better define the position of each of the drones in the three-dimensional (3D) space. The additional beacon 302 broadcasts and/or emits RF and/or light signals (e.g. 306a, 306m, 306b, 306c) which are received and/or observed at each of the drones in group 110, respectively.

In some aspects, the drones may be configured to rotate to fine-tune the direction finding capability of the system by observing the changes in the RF signal and/or light signal reception with respect to its internal direction sensors (e.g. compass) as shown by arrow 310a for drone 110a. In this manner, the drones may be configured to better determine the positions of the beacons based on the additional information gathered by such techniques. The drones may be configured, for example, to compare the signal(s) received from a beacon at a first orientation with a second orientation, where each of the first and second orientations have a different bearing with respect to a first direction (e.g. North, N).

FIG. 4 shows a direction finding system 400 illustrated with multiple subsets of drones which make up the overall drone swarm according to some aspects. It is appreciated that system 400 is exemplary in nature and may thus be simplified for purposes of this explanation.

System 400 may function similarly to the systems described in FIGS. 2 and 3. Although only one beacon 202 is shown in system 400, it is appreciated that one or more beacons may be used to improve the direction and positional calculations of the overall system. In system 400, a plurality of drone subsets 412-416 of the overall swarm are shown. Each of subsets 412-416 may include two or more drones. Although two drones are shown in subset 412, five drones shown in subset 414, and four drones in subset 416, it is appreciated that other numbers of drones in the subsets may also be employed to implement the methods and schemes disclosed herein.

In system 400, in addition to implementing the methods and schemes described in FIGS. 2 and 3, each of master drones 412m-416m in subsets 412-416 may be configured to communicate with other master drones in the overall swarm, i.e. the master drones may be configured to communicate with one another as shown by arrows 422-426. Such communications may take place on a dedicated frequency reserved for inter-subset communication or on a shared frequency with other communications, i.e. intra-drone communications and/or beacon signal(s) frequency. In this manner, the master drones 412m-416m may be configured to coordinate the flight plans of each of the drones in their respective subset in order to reduce the chances of collisions with drones from other subsets.

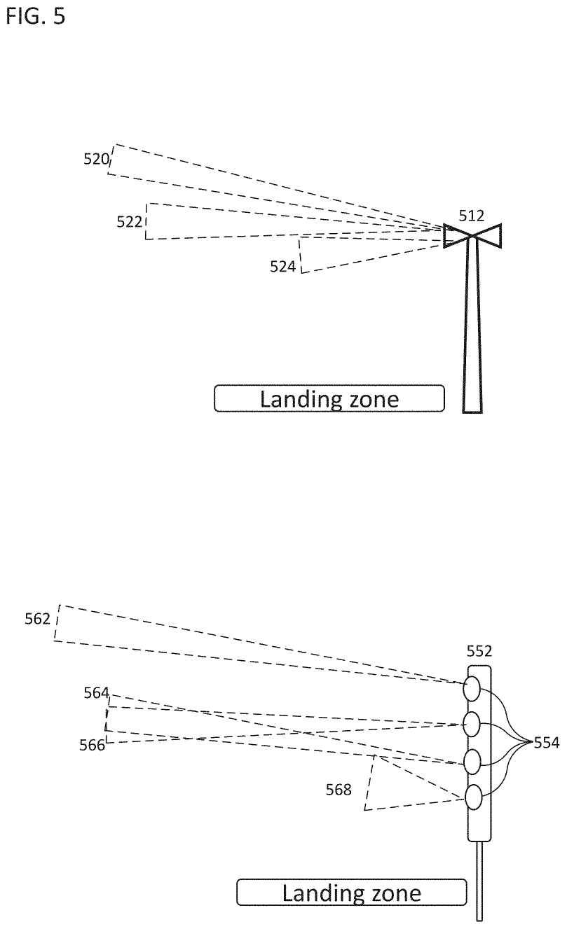

FIG. 5 shows examples of landing zones and beacons 512 and 552 (which may correspond to any one of beacons 202 and 302) with RF and light emitting capabilities, respectively, which may guide the drones to the landing zones upon loss of a GNSS signal according to some aspects. It is appreciated that FIG. 5 is exemplary in nature and may therefore be simplified for purposes of this explanation. It is also appreciated that beacons 512 and 552 may be combined into one beacon with both RF and light emitting capabilities.

Beacon 512 is an RF beacon capable of emitting one or more RF signals. The RF signals may be transmitted via one or more beams as shown by beams 520-524. Although three beams are shown, it is appreciated that any number of beams, i.e. one or more, may be transmitted. Accordingly, beacon 512 may be fitted with a plurality of antenna elements, e.g. a phased antenna array, configured for beamforming. In this manner the antenna elements may be controlled by control circuitry (shown in FIG. 6) which may manipulate the weights of each of the antenna elements to form constructive interference and destructive interference at certain phase angles so as to form one or more beams, e.g. each of beams 520-524.

Beacon 552 is a light emitting beacon capable of emitting one or more light signals. The light signals may be transmitted via lighting elements 554 which may work together to emit certain patterns (e.g. as shown in FIG. 8) or individually to emit light beams in specific directions as shown with light beams 563-568. Each of the lighting elements 554 may therefore be controlled to modify the emitted light intensity and the direction of the light beams.

FIG. 6 shows exemplary components of the different beacon sources according to some aspects. It is also appreciated that beacons 600 and 650 may be combined into one beacon with both RF and light emitting capabilities and may correspond to the beacons discussed throughout this disclosure (e.g. the beacons in FIGS. 2-5).

RF Beacon 600 may include, among other components, an antenna system 602, a radio transceiver 604, and a baseband circuit 606 with appropriate interfaces between each of them. In an abridged overview of the operation of RF beacon 600, RF beacon 600 may transmit and receive wireless signals via antenna system 602, which may be an antenna array including multiple antennas. Radio transceiver 604 may perform transmit and receive RF processing to convert outgoing baseband samples from baseband circuit 606 into analog radio signals to provide to antenna system 602 for radio transmission and to convert incoming analog radio signals received from antenna system 602 into baseband samples to provide to baseband circuit 606.

Baseband circuit 606 may include a controller 610 and a physical layer processor 608 which may be configured to perform transmit and receive PHY processing on baseband samples received from radio transceiver 604 to provide to a controller 610 and on baseband samples received from controller 610 to provide to radio transceiver 604. Controller 610 may control the communication functionality of beacon 600 according to the corresponding radio communication technology protocols, which may include exercising control over antenna system 602, radio transceiver 604, and physical layer processor 608. Each of radio transceiver 604, physical layer processor 608, and controller 610 may be structurally realized with hardware (e.g., with one or more digitally-configured hardware circuits or FPGAs), as software (e.g., as one or more processors executing program code defining arithmetic, control, and I/O instructions stored in a non-transitory computer-readable storage medium), or as a mixed combination of hardware and software. In some aspects, radio transceiver 604 may be a radio transceiver including digital and analog radio frequency processing and amplification circuitry. In some aspects, radio transceiver 604 may be a software-defined radio (SDR) component implemented as a processor configured to execute software-defined instructions that specify radio frequency processing routines. In some aspects, physical layer processor 608 may include a processor and one or more hardware accelerators, wherein the processor is configured to control physical layer processing and offload certain processing tasks to the one or more hardware accelerators. In some aspects, controller 610 may be a controller configured to execute software-defined instructions that specify upper-layer control functions. In some aspects, controller 610 may be limited to radio communication protocol stack layer functions, while in other aspects controller 610 may also be configured for transport, internet, and application layer functions.

RF beacon may also include an interface 620 for communicating with (e.g. receiving instructions from, providing data to, etc.) a central controller (not pictured) in the direction finding system according to some aspects. For example, in the case where multiple RF beacons are deployed, a central controller may be configured to communicate with and control each of the RF beacons so as to better coordinate the RF signals sent out in the emergency procedure should a GNSS signal be lost.

Light beacon 650 may include, among other components, one or more lighting elements 652-656 and one or more control circuits 658. Furthermore, an interface 660 may be included which functions similarly to the interface 620 described above. The light beacon 650 may include tube, honeycomb, optical, or similar structures, e.g. shown in 652-656, to control the visibility/direction of light beams 652-656 as instructed by the one or more control circuits 658. Accordingly, an appropriate interface between the one or more control circuits 658 and each of the lighting elements 652-656 may be included.

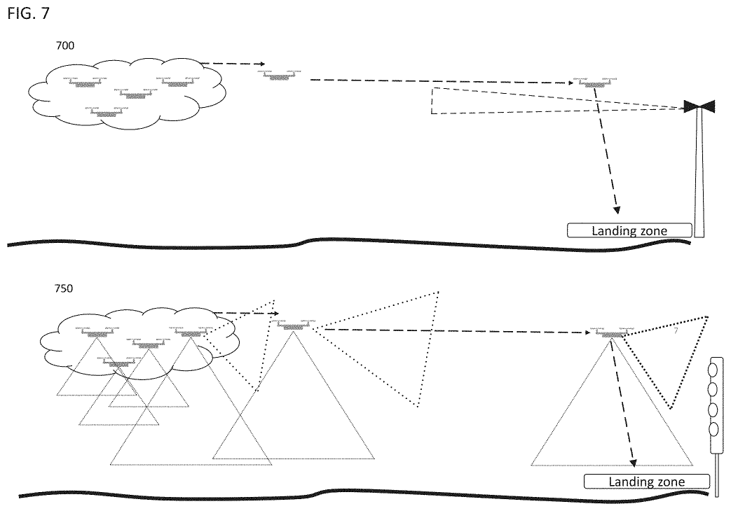

FIG. 7 shows two exemplary illustrations 700 and 750 in which an RF beacon and a light beacon guide a subset of drones to a landing zone according to some aspects. While one drone is shown as being directed towards the landing zone in each respective illustration, it is appreciated that the entire subset inclusive of the drone shown as being directed towards the landing zone may be directed to the landing zone in a similar fashion. Accordingly, each of the drones in the subset may coordinate their flight plans with one another so as to avoid or minimize any collisions. As shown in 750, the drones may be configured with one or more rotatable camera modules so as to cover a greater viewing angle than a single fixed camera module (e.g. as shown by the two viewing angles (i.e. dashed triangles) emitting from the drone as it approaches the landing zone).

FIG. 8 shows a drone side perspective in a direction finding system according to some aspects. It is appreciated that FIG. 8 is exemplary in nature and may therefore be simplified for purposes of this explanation.

Drone 110 may have a viewing angle, 810, and a known location/direction against one of the other sensors, e.g. relative to one of the cardinal directions 820 as provided by an internal compass, magnetometer, or the like. As also described herein, viewing angle 810 may be fixed with respect to the drone 110, or it may be rotated to scan across a wider range as shown by arrow 812. The box 802 may be indicative of the drone's camera view, and light pattern 804 may be the visible pattern of light at the drone as emitted by a light beacon in a direction finding system according to some aspects. It is appreciated that light pattern 804 is exemplary and other light patterns visible to the drone may be transmitted by the light beacons. The camera module of drone 110 may be aligned with an internal compass, magnetometer, etc., with high accuracy and based on data from both sources (e.g. direction data and camera module data, as well as data from other drones in the subset), a direction of the landing zone may be calculated.

In some aspects, the direction finding system may include a series of guiding lights that drones may use to find a safe path home, e.g. a landing zone or back to the launch pad. Additionally, one or more camera modules operating in conjunction with the guiding lights may be included so as to monitor drones in real time and provide additional information to a central controller which may adjust the guiding lights to provide better guidance to the drones. The series of guiding lights may be implemented in conjunction with the light and/or RF beacon systems of this disclosure.

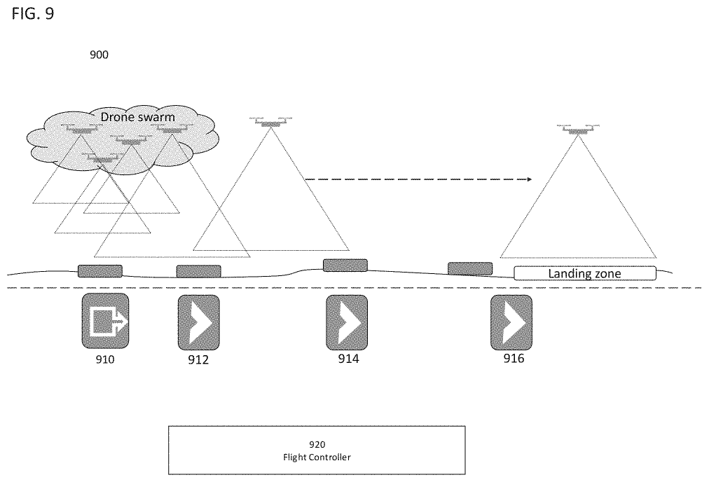

FIG. 9 shows a direction finding system 900 with a series of light sources to guide drones to a predetermined location, e.g. a landing zone, according to some aspects. It is appreciated that system 900 is exemplary in nature and may thus be simplified for purposes of this explanation.

A series of guiding lights 910-916 (i.e. indicator lights) is placed in the area of the drones and arranged so that the drones may follow the series of lights to a landing zone, for example. Although shown located at the ground level in system 900, it is appreciated that the lights may be placed in other areas which are visible to camera modules of the drones, e.g. in an indoor environment, the lights may be placed on the ceiling and/or on walls. A flight controller 920 may be configured to control the light emitted by each of the series of guiding lights 910-916 (i.e. indicator lights) via a wired interface (not shown) or wirelessly. Accordingly, each of the lights may include wired interfaces to connect to flight controller 920 and/or RF transceivers to receive signals from the flight controller 920. In some aspects, the series of lights may be outfitted on guidance drones, which may themselves be controlled by a flight controller 920 and provide greater degree of dynamic adjustment to direction finding system 900 as the guidance drones may be moved to suit the system's 900 needs in real-time.

Indicator lights 910-916 may be configured to emit light in the visible spectrum, or in other spectrums such as IR, i.e. in any spectrum for which the drones have sensors and/or monitors (including cameras) configured to detect. The drones may include rotatable cameras or a multiple camera configuration (e.g. one camera to see downward if the guiding lights are at ground level and another camera to see forward) in order to follow the series of guiding lights back to the landing zone. In some aspects, in the case that all the drones have a rotatable camera, the system may not even require any series of lights on the ground and may instead only include a home beacon light as shown in 750. However, it is appreciated that system 900 may be implemented for drones with any type of camera module configuration.

As shown in system 900, the initial light in the series, i.e. light 910, may be placed beneath a “show” area to indicate a first general direction to take home, and indicator lights 912-916 may provide further guidance in between the “show” area and “home”, i.e. the landing zone. As shown in system 900, the blocks shown for indicator lights 910-916 point towards the sky and are visible to each of the drone's camera modules which are oriented towards the ground.

One or more of the lights of indicator lights 910-916 may be pulsed or shaped in different ways, so that the indicator lights 910-916 may also inform the distance to the landing zone, speeds or altitudes to fly at, spacing to keep (between drones), or any other information. As an example, the light patterns may show the distance to and/or the position of the next indicator light in the series of indicator lights 910-916 and the pulses of light of the indicator lights may show an altitude to fly at.

The indicator lights can be passive with a pre-defined pattern or those that can communicate with a control center, such as flight controller 920, can be dynamically changed upon changing command parameters as necessary. For example, a command request may be sent to the drones to change speeds and/or altitude, and the lights may be modified to change their pattern, color, intensity, or the like accordingly. The drones may also have pre-defined target positions relative to indicator lights so as to minimize collisions. In addition to being used upon loss of GNSS signal, the system shown in FIGS. 9-13 may be used in case of strong electromagnetic fields present in the area such that magnetometer readings are disturbed and the drones lose track of the directional orientation of the landing zone. This may occur, for example, if the internal direct current (DC) currents in a drone disturb the magnetometer or may occur due to external environmental effects.

Instead of arrows as shown in the indicator lights in system 900, other lighting element patterns may be employed, such as dot matrices. Using dot matrices may allow for greater flexibility in the communication of information as different light patterns (e.g. as shown in FIG. 8) may be transmitted, wherein each light pattern may communicate a distinct command to the drones.

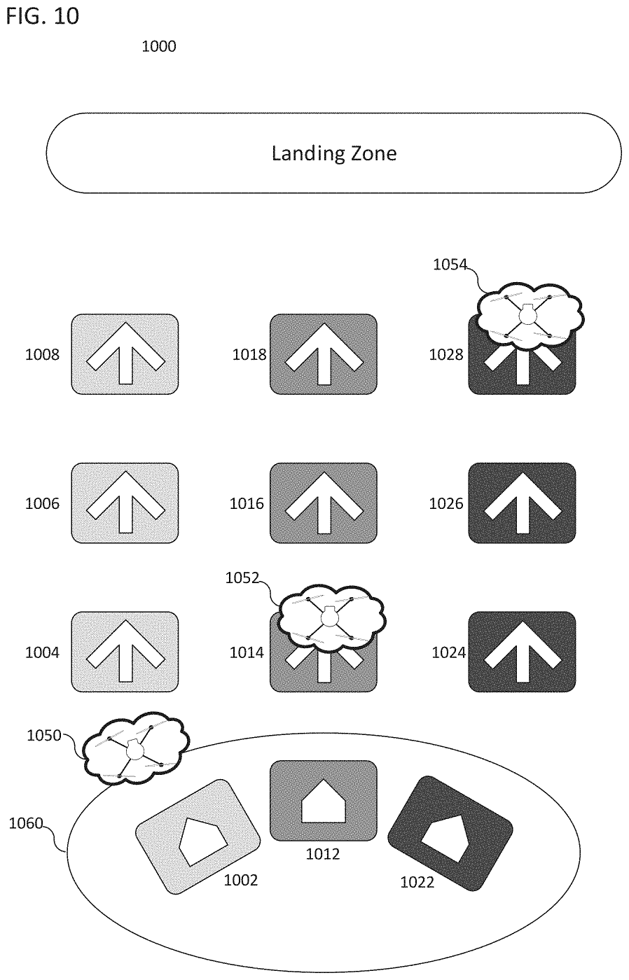

FIG. 10 shows an overhead view of a direction finding system 1000 with guiding (i.e. indicator) lights according to some aspects. It is appreciated that system 1000 is exemplary in nature and may thus be simplified for purposes of this explanation.

The initial indicator lights 1002, 1012, and 1022, placed in the “show” area (or area in which the drones are operating with under the guidance of GNSS signals) may each be directed to command a specific subset of drones to a particular route home. In system 1000, this is shown by the three different shades in each column of lights leading to the landing zone. Each indicator light series, i.e. each of series 1002-1008 (shown by light gray shading), series 1012-1018 (shown by dark gray shading), and series 1022-1028 (shown by black shading), may use a different color, symbols, pulsing, and/or light shaping to direct each of drone subsets 1050, 1052, and 1054, respectively, to the landing zone. Each of these different light features may be used to control speed, altitude, spacing, or other flight parameters. For example, in system 1000, each of the colors of the respective light series may control a speed at which each subset of drones flies at to stagger their arrival at the landing zone so as to minimize the chances of collision.

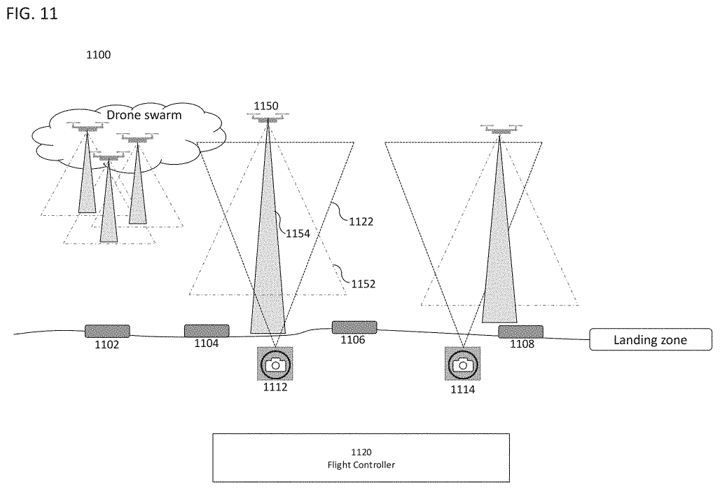

FIG. 11 shows a direction finding system with guiding lights and camera modules according to some aspects. It is appreciated that system 1100 is exemplary in nature and may thus be simplified for purposes of this explanation.

System 1100 may include guiding lights (i.e. indicator lights) 1102-1108, which may correspond to the indicator lights described elsewhere in this disclosure, as well as camera modules 1112-114, all of which may be connected to, either wirelessly or via a wired interface, with a central flight controller 1120. Each of the camera modules has an associated viewing angle and range, i.e. 1122 for camera module 1112, associated with it. Each of the drones has a camera viewing angle and a light source angle, i.e. for drone 1150, shown as 1152 (camera viewing angle) and 1154 (light source angle), associated with it. In this manner the drones may following the series of indicator lights 1102-1008 to the landing zone, and the camera modules 1112-1114 may track the drones and provide the flight controller with information so as to modify the lights in indicator lights 1102-1108 to alter the drone flight paths accordingly. For example, the flight controller 1120, via camera modules 1112 and/or 1114, may determine that there are subsets of drones heading towards a collision, and alter the indicator lights 1102-1108 color, pulse patterns, intensity, etc. to communicate to the drones to alter their flight paths (e.g. different altitude, speeds, etc.) to avoid collision on the way back to the landing zone.

In some aspects, the system 1100 using camera modules pointed towards the sky to detect the drones may deliver raw picture data to a main computing unit, e.g. flight controller 1120, or each camera module may be its own specific computing unit to deliver only pre-defined data to main controller, e.g. flight controller 1120.

In some aspects, the system 1100 may identify drones based on pulse/color of the ID light and estimate the speed based on image data. The system 1100 may use color, monochrome, thermal, hyperspectral, or multispectral cameras, or any combination of thereof, to detect drones in the sky.

The system 1100 may use its own specific pulse, pulse pattern, color, etc. to measure the latency time and synchronize the communication between the drones and flight control at the ground level. The system 1100 may repeat the latency measurement process periodically during active communications.

The system 1100 may detect each drone based on camera data (e.g. a signature appearance of the drone, a specific feature of the drone, an IR footprint, etc.) and “lock” the drone as target and with its own specific ID. There can also be communication between the camera modules, either wirelessly or via wired interface, so that when a drone moves towards the next camera unit, it will receive a message from another camera module that the drone with ID XXX1 (for example) is arriving in the viewing area of the next camera.

The indicator lights 1102-1108 may use a light source (e.g. LED or laser) with a limited viewing angle to improve the reliability of the system. In this case, there could be, for example, a mechanical structure which limits the viewing angle, such as a tube, honeycomb, or lens type of structure. The indicator lights in system 1100 can also be rotatable and the light can be adjustable (as discussed above and applicable throughout this disclosure). In some aspects, a narrow beam light source can be used also to ensure that only the right group of the drones sees the indicator lights intended for them. Another benefit of the limited viewing angle of the light sources is that the guiding lights are not visible (or are less visible) to people watching the light show.

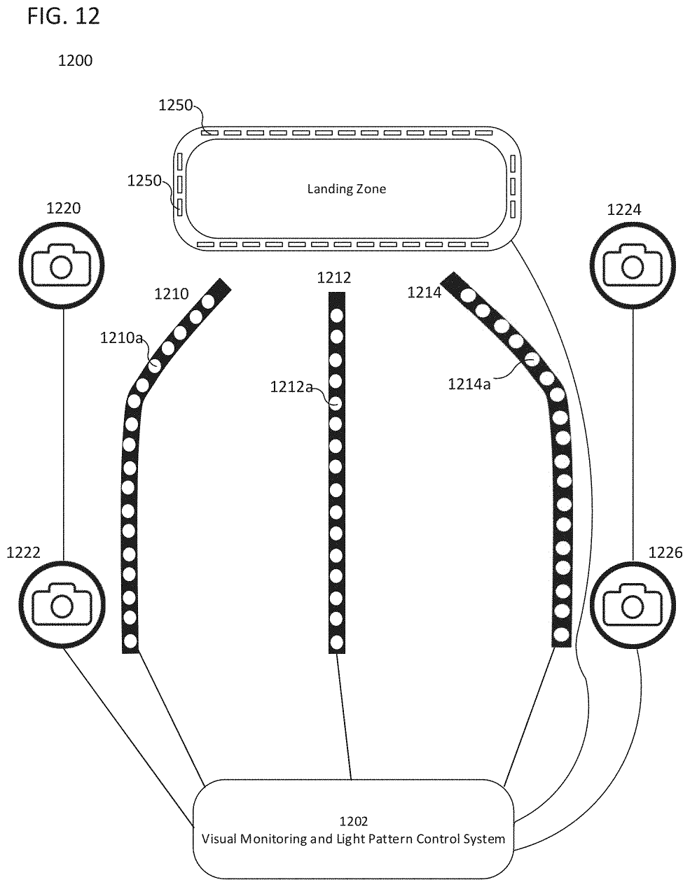

FIG. 12 shows an overhead view of a direction finding system 1200 according to some aspects. It is appreciated that system 1200 is exemplary in nature and may therefore be simplified for purposes of this explanation.

The landing zone may be surrounded by a plurality of lights (e.g. LEDs, red-green-blue (RGB) LEDs, incandescent light bulbs, etc.) to create a pattern to indicate to the drones that the landing zone is in the area. Each of light strips 1210, 1212, and 1214 may include a plurality of lights (shown by 1210a for light strip 1210, 1212a for light strip 1212, and 1214a for light strip 1214; although only one for each is shown, it is appreciated that each lighting strip may include a plurality of lights). Camera modules 1220-1226 may also be included to provide feedback to a flight controller as described in FIG. 11. The visual monitoring and light pattern control system 1202 may be integrated into said flight controller or may be coupled to the flight controller.

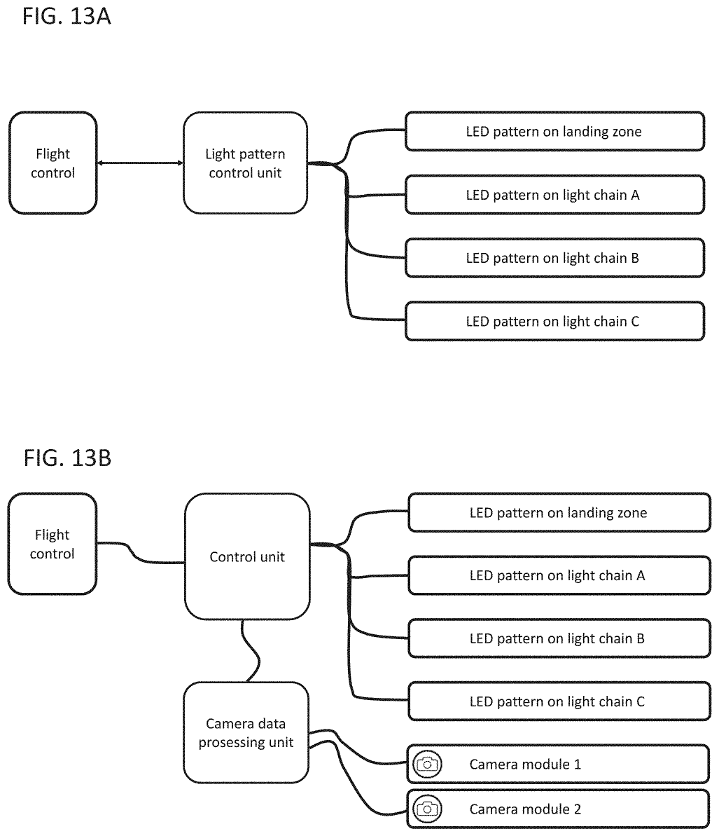

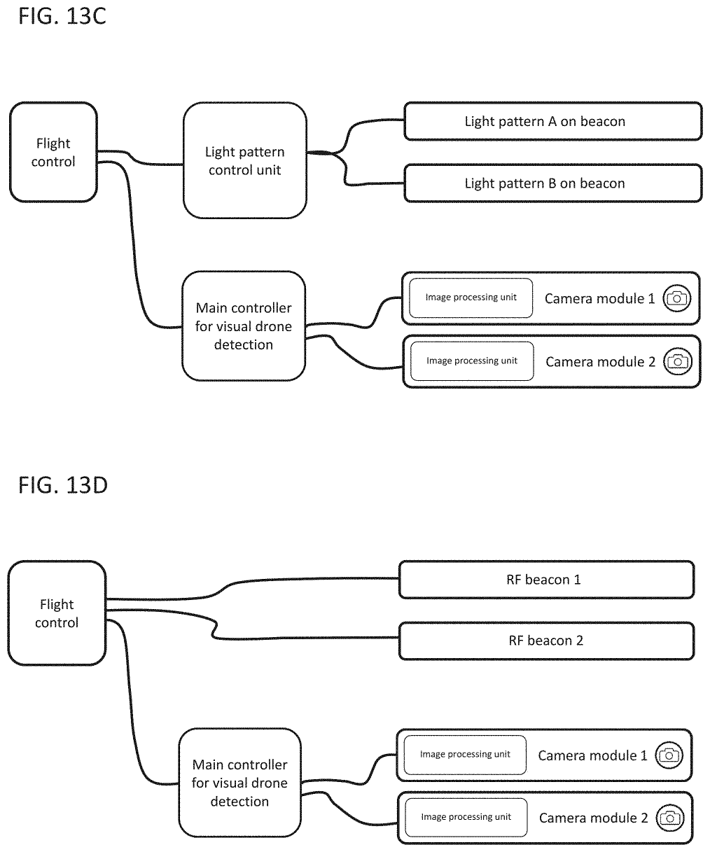

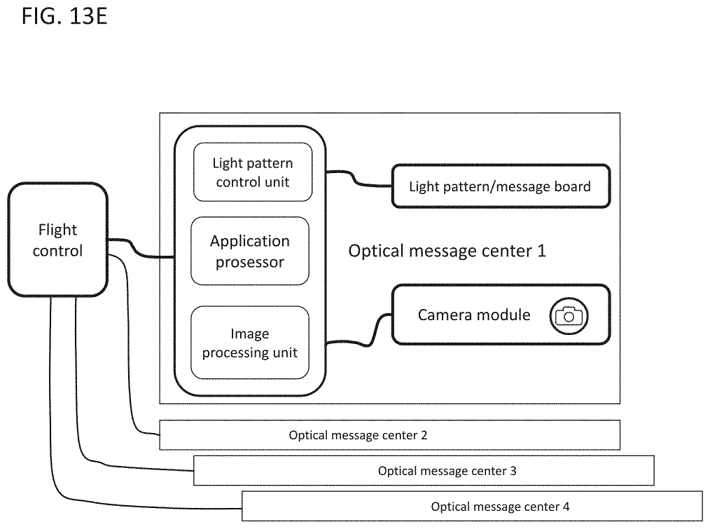

FIG. 13A-13E provide exemplary schematic diagrams illustrating the interfacing between different components of a direction finding system according to some aspects. These components may include flight control, a control unit, a camera data processing unit, camera module(s), light chain(s), RF beacons, light beacons, optical message centers, etc. It is appreciated that these figures are exemplary in nature and may therefore be simplified for purposes of this explanation.

For example, for the figures with camera modules, the system may use light and colors for communication in both directions and, in this case, a camera network is used at the ground level to observe drones, e.g. via lights on the drones. In one embodiment, the drones may blink their own code, which may be based on color and pulsed light. Also, for the figures with an optical message center, the optical message center includes all necessary parts for efficient and accurate drone detection and optical communication. For example, this may include a light pattern control unit, an application processor, an image processing unit, and a light pattern message board along with a camera module. This approach may be used to minimize latency in the communications between the flight control and the drones.

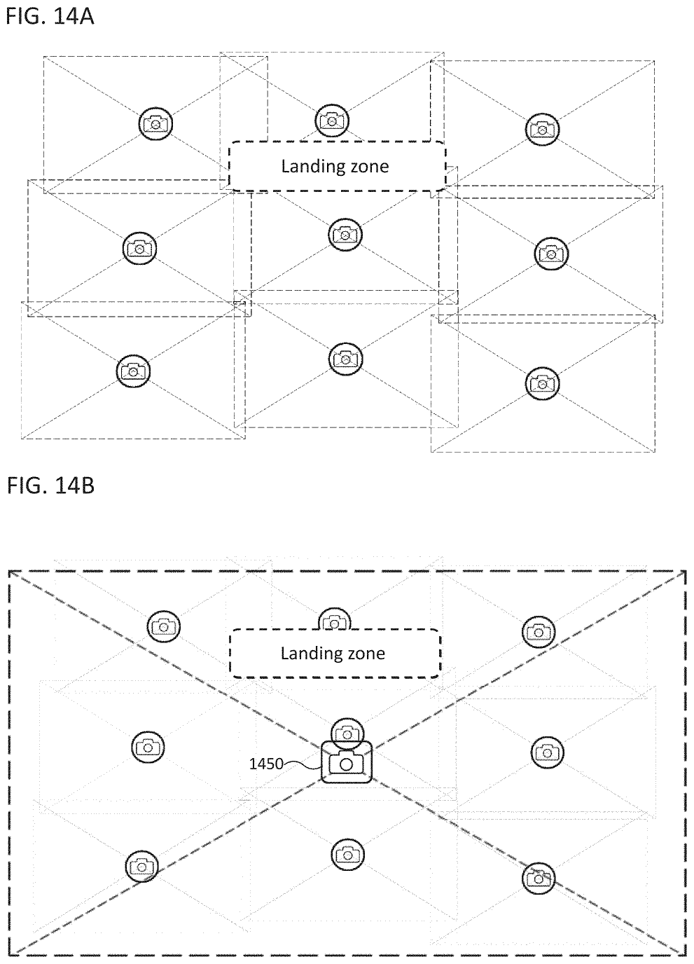

FIG. 14A-14B show exemplary camera module placements from an overhead view according to some aspects. It is appreciated that these figures are exemplary in nature and may therefore be simplified for purposes of this explanation.

For example, in FIG. 14A, each of the system's cameras point towards the sky and the views overlap to allow for seamless visibility to all the drones within the area. In FIG. 14A, all the cameras may have a uniform viewing angle. As another example, in FIG. 14B, the system may use camera modules with different viewing angles, for example, one camera with a 170 degree viewing angle (the centrally located camera 1450) and all other camera modules with a more narrow viewing angle, e.g. 60 degree viewing angles. The dotted lines in FIGS. 14A-14B indicate the viewing area of camera modules are the lowest height at which the drones may fly. The goal is that the drones are visible to at least one camera. The number of cameras and viewing angles of each camera may depend on the flight area of the drones, e.g. the show area in a drone light show.

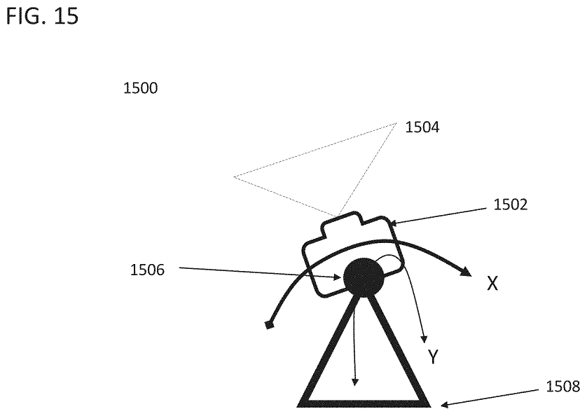

FIG. 15 shows an exemplary camera module 1500 according to some aspects. It is appreciated that camera module is exemplary in nature and may therefore be simplified for purposes of this explanation.

Camera module 1500 may include the camera 1502 with an optical lens and associated viewing angle 1504 configured to receive image data, an electrically and/or mechanically adjustable camera holder 1506 configured to adjust the viewing angle 1504 of the camera 1502 in an X and/or Y direction, and a camera stand 1508 configured to hold the other components of the camera module 1500. The camera module 1500 may be adjustable via a manual or electrical controller in either the X direction, the Y direction, or in both, and, in some cases, may also be adjustable in the Z-direction (not shown, but would be up and down). The direction finding systems described herein may also implement any possible navigation/positioning systems (e.g. GPS, Galileo, etc.) so that control system knows the position and viewing area of each of the camera modules. Camera module 1500 may also include other components, such as, but not limited to: a barometer, an accelerometer, gyroscope, lux meter, etc., to improve the accuracy and the reliability of the direction finding system. The viewing area of the camera(s) can be adjusted during the flight operation.

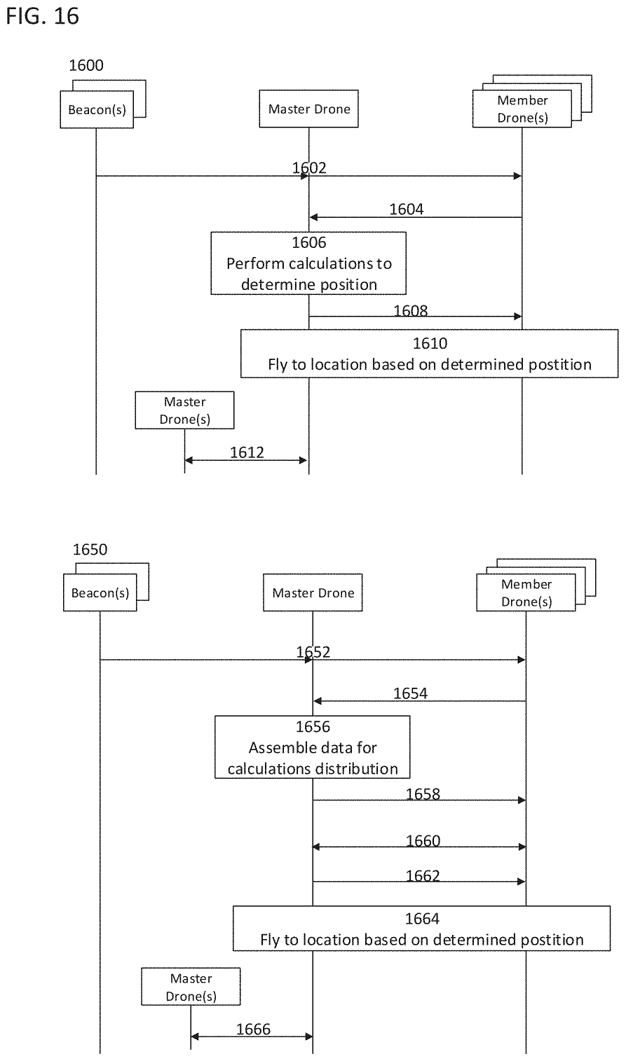

FIG. 16 shows message sequence charts (MSCs) 1600 and 1650 for communication between one or more beacons, a master drone, and one or more member drones of the subset of the master drone according to some aspects.

In MSC 1600, a master drone centered calculation of the direction and/or position of the one or more beacons (and therefore, the location of the landing zone relative to the one or more beacons) is shown. The one or more beacons may communicate RF signals to the master drone and the one or more member drones in 1602. Each of the member drones may transmit the raw data based off the RF signals received at each of the member drones to the master drone in 1604. This raw data may include the direction of the received RF signals with respect to data obtained from one or more other sensors, e.g. a magnetometer. Based off of the raw data received from each of the member drones, the master drones may perform calculations to determine a position of the one or more beacons, and accordingly, a landing zone. The master drone may communicate this information to the member drones in 1608, and thereby coordinate the flight path(s) of the drones in its cluster to the determined position. Optionally, the master drone may communicate the determined position and/or the flight path(s) of the drone(s) in its subset to one or more other master drone(s) in the overall swarm in 1612.

In another aspect, the member drone(s) may perform some calculations on the raw data prior to sending it to the master drone in 1604 so as to simplify the calculations performed by the master drone in 1606. For example, this may include calculations based on the RF signal data and its own internal sensor(s) (e.g. magnetometer or the like).

In MSC 1650, a distributed calculation of the direction and/or position of the one or more beacons (and therefore, the location of the landing zone relative to the one or more beacons) is shown. The one or more beacons may communicate RF signals to the master drone and the one or more member drones in 1652. Each of the member drones may transmit the raw data based off the RF signals received at each of the member drones to the master drone in 1654. The master drone may then assemble the data for distribution among the member drone(s) in 1656, where each member drone may be assigned a respective task of the overall position determination calculation so as to streamline the calculation process, i.e. each drone may specialize in a specific component of the overall calculation. In 1658, the master drones communicates to each of the member drone(s) their respective task along with the data necessary to perform the task. In 1660, each of the member drones communicates the completed task back to the master drone, which then determines the position of the RF beacon (and therefore, the landing zone, for example) based on the aggregation of the completed tasks from each of the member drones. In 1664, each of the master and the member drones may then fly to the determined position (i.e. safe landing zone), whereby the master drones can coordinate each of the flight paths and communicate this information to one or more other master drone(s) in the overall drone swarm 1666.

In some aspects, each of the member drones may be configured to share their information (e.g. as shared with the master drone in 1604 and 1654) directly with each of the other drones in the group, i.e. with the master and other member drones in the subset. The master drone may then coordinate the calculation to determine the position of the beacon(s), or each of the drones in the subset may independently determine the position of the beacon(s) based on all the information received from the other drones in its subset.

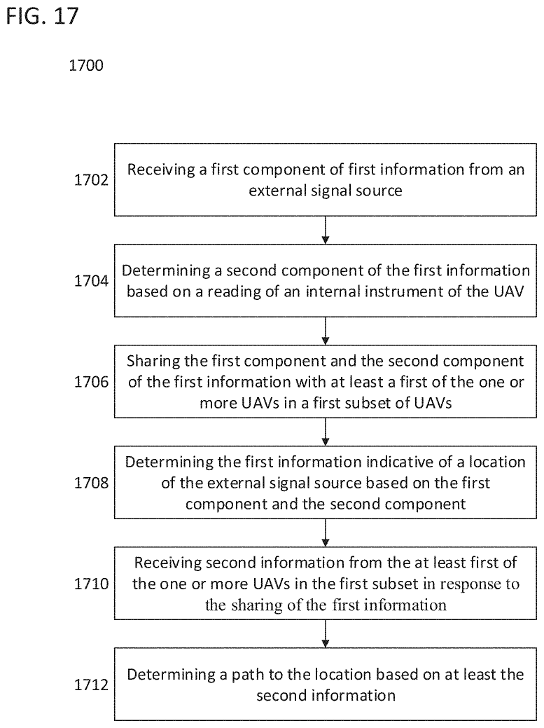

FIG. 17 shows a flowchart 1700 depicting a method for an autonomous device, e.g. a UAV, to determine a location according to some aspects. The location may be determined without any GNSS guidance, e.g. the GNSS signal may be lost or fall below a threshold indicating that the GNSS signal is reliable. It is appreciated that flowchart 1700 is exemplary in nature and may include additional features as discussed throughout this disclosure.

The method may include receiving a first component of first information from an external signal source 1702; determining a second component of the first information based on a reading of an internal instrument of the UAV 1704; sharing the first information with at least a first of the one or more UAVs in a first subset of UAVs 1706; determining the first information indicative of a location of the external signal source based on the first component and the second component 1707; receiving second information from the at least first of the one or more UAVs in the first subset in response to the sharing of the first information 1710; and determining a path to the location based on at least the second information 1712.

In some aspects, the determining of the first information based on the first component and the second component may be performed at the UAV, and then shared with the at least first of the one or more UAVs in the first subset of UAVs.

The first component of the first information may correspond to a signal received from one or more RF beacon and/or light sources as described herein. The second component of the first information may correspond to the reading of any one of the sensor, detectors, or other equipment of a UAV as described herein, e.g. the reading of an internal compass or magnetometer.

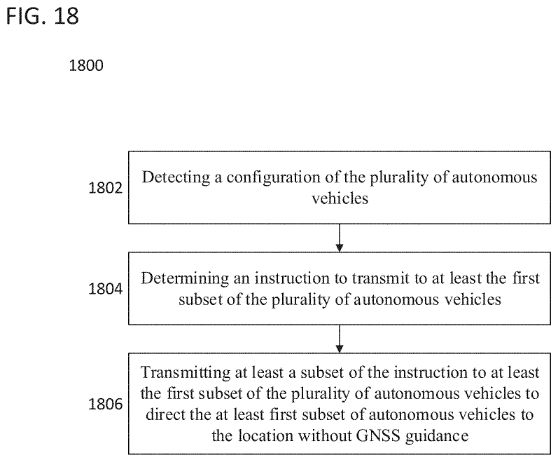

FIG. 18 shows a flowchart 1800 depicting a method for directing at least a first subset of a plurality of autonomous vehicles to a location without global navigation satellite system (GNSS) guidance according to some aspects. It is appreciated that flowchart 1800 is exemplary in nature and may include additional features as discussed throughout this disclosure.

The method may include detecting a configuration of the plurality of autonomous vehicles 1802; determining an instruction to transmit to at least the first subset of the plurality of autonomous vehicles 1804; and transmitting at least a subset of the instruction to at least the first subset of the plurality of autonomous vehicles to direct the at least first subset of autonomous vehicles to the location without GNSS guidance 1806.

FIG. 19 shows a direction finding system 1900 according to some aspects. It is appreciated that system 1900 is exemplary in nature and may therefore be simplified for purposes of this explanation.

The master drone 110m (or in some aspects, each drone in the group 110) may use an accurate clock system where the clock of each of the respective drones in group 110 may be synchronized. In this manner, the drones may estimate a distance to the beacon 202 based on a time and phase of the beacon signals. The system may use more than one frequency for direction finding. As an example, the master drone 110m may use two or more frequencies in different frequency bands to improve location accuracy. By using different frequencies, the radio frequency direction finding systems described herein may also be able to use different polarizations. As described with respect to FIG. 3, the drones in the system may rotate to determine the direction of the RF source. Additionally, or in the alternative, the drones may adjust the radiation pattern of their antennas (mechanically and/or electrically) to assist in discovering the source of the RF signals (i.e. the beacon 202). System 1900 shows the radiation patterns 1902-1908 of the direction finding antenna for each of the respective drones in drone group 100. As shown in system 1900, there is a clear null point in the radiation pattern of each drone's antenna (low antenna gain) to a known direction, where the methods and devices described herein may then be configured to calculate the direction based on the received signal and the magnetometer data.

FIG. 20 shows a drone with an exemplary radiation pattern 2002 of a direction finding antenna according to some aspects. Instead of having a minimum point in the antenna radiation pattern in a known direction like that shown in FIG. 19, radiation pattern 2002 has a clear maximum gain to a known direction. This may be used, along with the magnetometer data of the drone 110a, to be able to determine a direction of a RF source as described in the methods and devices of this disclosure.

As shown in both FIGS. 19 and 20, the arrow marked “N” is the indicator data from the magnetometer that is pointing North. The drones can then compare the magnetometer data to the received RF signal to determine the direction of the RF source, i.e. the beacon. To ensure that the drones employing the RF based system can find the direction of the RF source, the drone may use a directional antenna structure with a known and clear minimum or maximum point in the antenna gain as shown in either FIG. 19 or 20.

In some aspects, the method may further include transmitting the at least the subset of the instruction by changing at least one of a pattern, intensity, color, or pulse pattern of one or more of a plurality of indicator lights. Additionally, the method may include detecting a change in the configuration of the plurality of autonomous vehicles; determining an updated instruction to transmit to the at least the first subset of the plurality of autonomous vehicles based on the change in the configuration; changing at least one of the pattern, intensity, color, or pulse pattern of one or more of the plurality of indicator lights to transmit the updated instruction.

Further, various examples according to some aspects will be described in the following:

In Example 1, a device, for an unmanned aerial vehicle (UAV), configured to determine a location, the device including one or more receivers or sensors configured to receive a first information, wherein at least a first of the one or more receivers or sensors is configured to obtain at least a first component of the first information from an external source, wherein one of the one or more receivers or sensors includes a transceiver configured to communicate with one or more other UAVs in a first subset inclusive of the UAV; one or more processors configured to share the first information with at least a first of the one or more UAVs in the first subset and receive a second information from at least the first of the one or more UAVs in response to the sharing of the first information; and determine a path to the location based on at least the second information.

In Example 2, the subject matter of Example(s) 1 may include wherein the device is configured to determine the location independent of guidance from a global navigation satellite system (GNSS) or an ultra-wideband (UWB) system.

In Example 3, the subject matter of Example(s) 1-2 may include wherein the path to the location is based on the first information in addition to the second information.

In Example 4, the subject matter of Example(s) 1-3 may include wherein the UAV is configured to exclusively share the first information with the at least a first of the one or more other UAVs in the first subset and not share the first information directly with a second subset of UAVs.

In Example 5, the subject matter of Example(s) 1-4 may include wherein the one or more processors are configured to calculate the location based on a combination of the first information and the second information.

In Example 6, the subject matter of Example(s) 1-5 may include wherein the second information includes information of the external source from a perspective from each of the other UAVs in the first subset.

In Example 7, the subject matter of Example(s) 1-5 may include wherein the second information includes a calculation of the location determined by the at least the first of the one or more UAVs in the first subset.

In Example 8, the subject matter of Example(s) 1-5 may include wherein the second information includes a command to perform a calculation based on a subset of the first information received at each of the one or more other UAVs in the first subset.

In Example 9, the subject matter of Example(s) 8 may include wherein the UAV is configured to share results of the performed calculation with at least the first of the one or more UAVs in the first subset.

In Example 10, the subject matter of Example(s) 9 may include wherein one or more processors are configured to receive third information from the at least the first of the one or more UAVs, the third information including results of calculations performed at each of the other UAVs in the first subset.

In Example 11, the subject matter of Example(s) 10 may include wherein the determined path to the location is based on the third information.

In Example 12, the subject matter of Example(s) 1-11 may include wherein there is at least one additional external source, wherein the first of the one or more receivers is configured to receive an additional subset of the first information from each of the at least one additional external sources.

In Example 13, the subject matter of Example(s) 12 may include wherein the at least one additional external source is a RF beacon or a light emitting beacon.

In Example 14, the subject matter of Example(s) 1-13 may include wherein the external source is a radio frequency (RF) beacon.

In Example 15, the subject matter of Example(s) 1-14 may include wherein the external source is a light beacon.

In Example 16, the subject matter of Example(s) 1-5 may include wherein the external source is a beacon capable of emitting RF signals and light signals.

In Example 17, the subject matter of Example(s) 1-16 may include wherein the one or more receivers or sensors includes a directional sensor including at least one of a light sensor, camera, magnetometer, barometer, motion detector, infrared detector or sensor, or compass configured to obtain a second component of the first information, and a second component of the first information is provided by the directional sensor.

In Example 18, the subject matter of Example(s) 1-17 may include the one or more processors configured to direct the UAV to the location via the path.

In Example 19, a device, for an unmanned aerial vehicle (UAV) of a first subset of a plurality of UAVs, configured to determine a location, the device including one or more receivers or sensors configured to receive first information, each of the one or more receivers or sensors configured to obtain at least a first component of the first information from a source external to the first subset of the plurality of UAVs, wherein one of the one or more receivers or sensors includes a transceiver configured to communicate with each of the other UAVs in the first subset; and one or more processors configured to: receive a respective first information from each of other UAVs in the first subset; determine second information based on a combination of the respective information from each of the other UAVs in the first subset of the plurality of UAVs and the first information; and communicate the second information to each of the other UAVs in the first subset, wherein the second information is indicative of the location.

In Example 20, the subject matter of Example(s) 19 may include wherein the device is configured to determine the location independent of guidance from a global navigation satellite system (GNSS) or an ultra-wideband (UWB) system.

In Example 21, the subject matter of Example(s) 19-20 may include wherein the one or more processors are configured to communicate the second information exclusively with each of the UAVs in the first subset.

In Example 22, the subject matter of Example(s) 19-21 may include, wherein each of the respective first information includes information received at each of the respective UAVs in the first subset from the external source.

In Example 23, the subject matter of Example(s) 19-22 may include the one or more processors further configured to distribute tasks to each of the other UAVs in the first subset, wherein the tasks includes calculations based on the first information.

In Example 24, the subject matter of Example(s) 23 may include the one or more processors further configured to receive results of the calculations from each of the other UAVs in the first subset and determine the second information from the calculations.

In Example 25, the subject matter of Example(s) 19-24 may include, wherein there is at least one additional external source, wherein the first of the one or more receivers is configured to receive an additional subset of the first information from each of the at least one additional external sources.

In Example 26, the subject matter of Example(s) 25 may include, wherein the at least one additional external source is a RF beacon or a light emitting beacon.

In Example 27, the subject matter of Example(s) 19-26 may include wherein the external source is a radio frequency (RF) beacon.

In Example 28, the subject matter of Example(s) 19-27 may include wherein the external source is a light beacon.

In Example 29, the subject matter of Example(s) 19-28 may include wherein the external source is a beacon capable of emitting RF signals and light signals.

In Example 30, the subject matter of Example(s) 19-29 may include wherein the one or more receivers or sensors include at least one of a light sensor, camera, magnetometer, barometer, motion detector, infrared detector or sensor, or compass configured to obtain a second component of the first information.

In Example 31, the subject matter of Example(s) 19-30 may include the one or more processors configured to coordinate a flight path of each of the other UAVs in the first subset to the location.

In Example 32, the subject matter of Example(s) 19-31 may include the one or more processors configured to communicate with another device in a second subset of the plurality of UAVs, the second subset of the plurality of UAVs being distinct from the first subset of the plurality of UAVs.

In Example 33, a system including a plurality of UAVs and at least one localization device, wherein the system is configured to direct at least a first subset of the plurality of UAVs to a location, wherein each UAV of the plurality of UAVs includes: one or more receivers or sensors configured to receive a first information, each of the one or more receivers or sensors configured to obtain at least a component of the first information from the at least one localization device, wherein one of the one or more receivers or sensors includes a transceiver configured to communicate with at least a first other UAV in the first subset, and one or more processors configured to share the received first information with the at least a first other UAV in the first subset, receive a second information from the at least first other UAV in the first subset, and determine the location based on at least one of the first information and/or the second information; wherein each of the at least one localization device includes one or more processors configured to configured to receive an instruction and produce the at least first subset of the first information based on the instruction, and a transmission source configured to transmit the first subset of the first information in a direction of the at least a first subset of UAVs of the plurality of UAVs.

In Example 34, the subject matter of Example(s) 33 may include wherein the system is configured to direct the at least first subset of the plurality of UAVs to the location independent of guidance from a global navigation satellite system (GNSS)) or an ultra-wideband (UWB) system.

In Example 35, the subject matter of Example(s) 33-34 may include further including a plurality of localization devices.

In Example 36, a method for determining a location in an unmanned aerial device (UAV), the method including receiving a first component of a first information from an external signal source; determining a second component of the first information based on a reading of an internal instrument of the UAV; sharing the first information with at least a first of the one or more UAVs in a first subset of UAVs; determining the first information indicative of a location of the external signal source based on the first component and the second component; receiving a second information from the at least first of the one or more UAVs in the first subset in response to the sharing of the first information; and determining a path to the location based on at least the second information.

In Example 37, a direction finding system configured to direct at least a first subset of a plurality of autonomous vehicles to a location without global navigation satellite system (GNSS) or ultra-wideband (UWB) system guidance, wherein the direction finding system includes one or more detectors configured to monitor a configuration of the plurality of autonomous vehicles; one or more processors configured to receive the configuration from the one or more detectors and determine an instruction to transmit to at least the first subset of the plurality of autonomous vehicles; and a plurality of indicator lights each configured to transmit at least a subset of the instruction to at least the first subset of the plurality of autonomous vehicles to direct the at least first subset of autonomous vehicles to the location without GNSS guidance or an ultra-wideband (UWB) guidance.

In Example 38, the subject matter of Example(s) 37 may include wherein the plurality of indicator lights are configured to transmit at least the subset of the instruction by changing at least one of a pattern, intensity, color, or pulse pattern of one or more of the plurality of indicator lights.

In Example 39, the subject matter of Example(s) 38 may include wherein upon detecting a change in the configuration of the plurality of autonomous vehicles via the one or more detectors, the one or more processors are configured to determine an updated instruction to transmit to the at least the first subset of the plurality of autonomous vehicles and change at least one of the pattern, intensity, color, or pulse pattern of one or more of the plurality of indicator lights to transmit the updated instruction.

In Example 40, a method for directing at least a first subset of a plurality of autonomous vehicles to a location without global navigation satellite system (GNSS) guidance or ultra-wideband (UWB) system, the method including: detecting a configuration of the plurality of autonomous vehicles; determining an instruction to transmit to at least the first subset of the plurality of autonomous vehicles; and transmitting at least a subset of the instruction to at least the first subset of the plurality of autonomous vehicles to direct the at least first subset of autonomous vehicles to the location without GNSS or UWB system guidance.

In Example 41, the subject matter of Example(s) 40 may include transmitting the at least the subset of the instruction by changing at least one of a pattern, intensity, color, or pulse pattern of one or more of a plurality of indicator lights.

In Example 42, the subject matter of Example(s) 41 may include detecting a change in the configuration of the plurality of autonomous vehicles; determining an updated instruction to transmit to the at least the first subset of the plurality of autonomous vehicles based on the change in the configuration; and changing at least one of the pattern, intensity, color, or pulse pattern of one or more of the plurality of indicator lights to transmit the updated instruction.

In Example 43, one or more non-transitory computer-readable media storing instructions thereon that, when executed by at least one processor of a communication device, direct the communication device to perform the method or realize a device as claimed in any preceding claim.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc. Also, it is appreciated that particular implementations of hardware and/or software components are merely illustrative, and other combinations of hardware and/or software that perform the methods described herein are within the scope of the disclosure.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device, for an unmanned aerial vehicle (UAV), configured to determine a location, the device comprising:
one or more receivers or sensors configured to receive first information, wherein at least a first of the one or more receivers or sensors is configured to obtain at least a first component of the first information from an external source, wherein one of the one or more receivers or sensors comprises a transceiver configured to communicate with one or more other UAVs in a first subset inclusive of the UAV; and
one or more processors configured to:
share the first information with at least a first of the one or more UAVs in the first subset and receive second information from at least the first of the one or more UAVs in response to the sharing of the first information; and
determine a path to the location based on at least the second information.

2. The device of claim 1, wherein the device is configured to determine the location independent of guidance from a global navigation satellite system (GNSS) or an ultra-wideband (UWB) system.

3. The device of claim 1, wherein the path to the location is based on the first information in addition to the second information.

4. The device of claim 1, wherein the UAV is configured to exclusively share the first information with the at least a first of the one or more other UAVs in the first subset and not share the first information directly with a second subset of UAVs.

5. The device of claim 1, wherein the second information comprises a calculation of the location determined by the at least the first of the one or more UAVs in the first subset.

6. The device of claim 1, wherein the second information comprises a command to perform a calculation based on a subset of the first information received at each of the one or more other UAVs in the first subset.

7. The device of claim 6, wherein the UAV is configured to share results of the performed calculation with at least the first of the one or more UAVs in the first subset.

8. The device of claim 7, wherein one or more processors are configured to receive third information from the at least the first of the one or more UAVs, the third information comprising results of calculations performed at each of the other UAVs in the first subset.

9. The device of claim 1, wherein there is at least one additional external source, wherein the first of the one or more receivers is configured to receive an additional subset of the first information from each of the at least one additional external sources.

10. The device of claim 1, wherein the external source is a radio frequency (RF) beacon.

11. The device of claim 1, wherein the external source is a light beacon.

12. The device of claim 1, wherein the one or more receivers or sensors comprises a directional sensor comprising at least one of a light sensor, camera, magnetometer, barometer, motion detector, infrared detector or sensor, or compass configured to obtain a second component of the first information, and a second component of the first information is provided by the directional sensor.

13. The device of claim 1, the one or more processors configured to direct the UAV to the location via the path.

14. A device, for an unmanned aerial vehicle (UAV) of a first subset of a plurality of UAVs, configured to determine a location, the device comprising:
one or more receivers or sensors configured to receive first information, each of the one or more receivers or sensors configured to obtain at least a first component of the first information from a source external to the first subset of the plurality of UAVs, wherein one of the one or more receivers or sensors comprises a transceiver configured to communicate with each of the other UAVs in the first subset; and
one or more processors configured to:
receive a respective first information from each of other UAVs in the first subset;
determine second information based on a combination of the respective information from each of the other UAVs in the first subset of the plurality of UAVs and the first information; and
communicate the second information to each of the other UAVs in the first subset, wherein the second information is indicative of the location.

15. The device of claim 14, wherein the device is configured to determine the location independent of guidance from a global navigation satellite system (GNSS) or an ultra-wideband (UWB) system.

16. The device of claim 14, the one or more processors configured to coordinate a flight path of each of the other UAVs in the first subset to the location.

17. The device of claim 14, the one or more processors configured to communicate with another device in a second subset of the plurality of UAVs, the second subset of the plurality of UAVs being distinct from the first subset of the plurality of UAVs.

18. A direction finding system configured to direct at least a first subset of a plurality of autonomous vehicles to a location without global navigation satellite system (GNSS) or ultra-wideband (UWB) system guidance, wherein the direction finding system comprises:
one or more detectors configured to monitor a configuration of the plurality of autonomous vehicles;
one or more processors configured to receive the configuration from the one or more detectors and determine an instruction to transmit to at least the first subset of the plurality of autonomous vehicles; and
a plurality of indicator lights each configured to transmit at least a subset of the instruction to at least the first subset of the plurality of autonomous vehicles to direct the at least first subset of autonomous vehicles to the location without GNSS guidance or an ultra-wideband (UWB) guidance.

19. The system of claim 18, wherein the plurality of indicator lights are configured to transmit at least the subset of the instruction by changing at least one of a pattern, intensity, color, or pulse pattern of one or more of the plurality of indicator lights.

20. The system of claim 19, wherein upon detecting a change in the configuration of the plurality of autonomous vehicles via the one or more detectors, the one or more processors are configured to determine an updated instruction to transmit to the at least the first subset of the plurality of autonomous vehicles and change at least one of the pattern, intensity, color, or pulse pattern of one or more of the plurality of indicator lights to transmit the updated instruction.
